(19) United States
(12) Patent Application Publication
(10) Pub. No.: US 2013/0275156 A1
(43) Pub. Date: Oct. 17, 2013

(54) EDUCATIONAL SYSTEMS AND METHODS EMPLOYING CONFIDENTIAL MEDICAL CONTENT

(71) Applicant: IMED MEDIA INC., Russell (CA)

(72) Inventors: James Kinkaid, Russell (CA); Ravi Mohan, Ottawa (CA)

(73) Assignee: iMed Media Inc., Russell (CA)

(21) Appl. No.: 13/863,537

(22) Filed: Apr. 16, 2013

Related U.S. Application Data
(60) Provisional application No. 61/624,407, filed on Apr. 16, 2012.

(51) Int. Cl. G06Q 50/24; G06Q 50/20; G06Q 10/00

(52) U.S. Cl. CPC G06Q 50/24; G06Q 10/00; G06Q 50/20
USPC 705/3

(57) ABSTRACT

Due to the direct potential impact to patients medical training is exhaustive but also more complex individuals are unique and other sciences applying similar treatment regimens may result in radically different outcomes. Further, the tools for detailed diagnosis absent surgical intervention are complex, expensive, and require significant interpretation. Whilst establishing virtual learning environments would be beneficial in the medical field Government regulations on the privacy of confidential information conflict by restricting the distribution and use of patient medical records. Accordingly, a medical education system would beneficially integrate the different legal and medical educational requirements automatically as well as addressing other situations which are more difficult to manage when one physician contacts another seeking content for a training program. Further, it would be beneficial for such an educational content generator to provide medical professionals with the additional tools and resources to generate, manage, track and supervise the educational process.

### CROSS-REFERENCE TO RELATED APPLICATIONS

This patent application claims the benefit of U.S. Provisional Patent Application 61/624,407, which was filed on Apr. 16, 2012 and was entitled “Educational Systems and Methods Employing Confidential Medical Content.”

### FIELD OF THE INVENTION

The present invention relates to medical education and more specifically to managing patient clinical data within regulatory requirements.

### BACKGROUND OF THE INVENTION

Medical education refers to education related to the practice of being a medical practitioner, either the initial training to become a doctor (i.e., medical school and internship) and the additional training thereafter (e.g., residency and fellowship) or to become a registered nurse and continuous education thereafter. Whilst medical education and training varies considerably across the world it is typically considered to be expensive, long, and difficult.

However, the financial returns for completing such an education are significant. Within the United States the average salary for a staff Registered Nurse (RN) in the United States in 2007 was over $60,000 compared to real median earnings of men and women of approximately $45,000 and $35,000 respectively, or approximately 5 times the national minimum wage in 2007. The average salaries for General Physicians and Surgeons by comparison were approximately $155,000 and $220,000, or approximately 13 and 18 times the national minimum wage in 2007.

Registered Nurses:

In the United States, an RN's scope of practice is determined by Nurse Practice Act of the state or territory in which an RN is licensed. Each state has its own laws, rules, and regulations governing nursing care. In some states the terms “nurse” or “nursing” may only be used in conjunction with the practice of a Registered Nurse (RN) or licensed practical or vocational nurse (LPN/LVN). The scope of practice for a registered nurse is wider than for an LPN/LVN because of the level and content of education as well as what the Nurse Practice Act says about the respective roles of each. RNs may be employed by hospitals but may also be employed by physicians, attorneys, insurance companies, governmental agencies, community/public health agencies, private industry, school districts, ambulatory surgery centers, among others. Some registered nurses are independent consultants who work for themselves, while others work for large manufacturers or chemical companies. Research Nurses conduct or assist in the conduct of research or evaluation (outcome and process) in many areas such as biology, psychology, human development, and health care systems.

Within the United States an RN will generally have completed one of three initial educational programs prior to passing their RN examination. These initial programs are a Diploma in Nursing, an Associate Degree in Nursing (ADN) and a Bachelor of Science (B.Sc.N) in Nursing although the hospital based Diploma in Nursing represents a small minority of RNs overall. Whilst the AND is a two-year college degree its prerequisite and co-requisite courses typically stretch the process to 3 years or greater. The B.Sc.N is a four year degree that also prepares nurses for graduate level education subsequently.

Such gradual level education is typically done at the master's and doctoral levels and prepares the graduate for specialization as an advanced practice registered nurse (APRN) or for advanced roles in leadership, management, or education. Areas of advanced nursing practice include that of a nurse practitioner (NP), a certified nurse midwife (CNM), a certified registered nurse anesthetist (CRNA), or a clinical nurse specialist (CNS). Nurse practitioners work assessing, diagnosing and treating patients in fields as diverse as family practice, women's health care, emergency nursing, acute/critical care, psychiatry, geriatrics, or pediatrics, while a CNS usually works for a facility to improve patient care, do research, or as a staff educator. The clinical nurse leader (CNL) is an advanced generalist who focuses on the improvement of quality and safety outcomes for patients or patient populations from an administrative and staff management focus. Doctoral programs in nursing prepare the student for work in nursing education, health care administration, clinical research, or advanced clinical practice. Most programs confer the Ph.D in nursing and Doctor of Nursing Practice (DNP).

Medical School:

In comparison medical education for doctors, physicians, and surgeons whilst longer proceeds on one path rather than the multiple routes for RNs. This process comprising medical school, internship, residency and potentially fellowship. Considering the United States a medical school is an institution educating physicians and although it may not technically require completion of a previous degree; most applicants are usually required to complete at least 3 years of “pre-med” courses at the University level as medical degrees are classified as second entry degrees. In medical school, study is divided into two roughly equal components: pre-clinical (consisting of didactic courses in the basic sciences) and clinical (clerkships consisting of rotations through different wards of a teaching hospital). The degree granted at the conclusion of the four years of study is Doctor of Medicine (M.D.) or Doctor of Osteopathic Medicine (D.O.), depending on the medical school; both degrees allow the holder to practice medicine after completing an accredited residency program. Historically, post-graduate medical education began with a free-standing, one-year internship and completion of this year continues to be the minimum training requirement for obtaining a general license to practice medicine in most states. Notwithstanding the trend toward internships integrated into categorical residencies, the one-year “traditional rotating internship” (sometimes called a “transitional year”) continues.

Residency:

Each of the specialties in medicine has established its own curriculum, which defines the length and content of residency training necessary to practice in that specialty. Programs range from three years after medical school for internal medicine to five years for surgery to seven to eight years for neurosurgery. This does not include research years that may last from one to four years if a PhD degree is pursued.

Fellowship:

Many highly specialized fields require formal training beyond residency including for example cardiology, endocrinology, oncology after internal medicine; cardiothoracic anesthesiology, cardiothoracic surgery, pediatric surgery, surgical oncology after general surgery; reproductive endocrinology/infertility, maternal-fetal medicine, gynecologic oncology after obstetrics/gynecology. These training programs are known as fellowships and their participant's fellows in order to denote that they already have completed a residency and are board eligible or board certified in their basic specialty. Such Fellowships typically range in length from one to three years.

Board Certification:

The physician or surgeon who has completed his or her residency and possibly fellowship training and is in the practice of their specialty is known as an attending physician. Physicians then must pass written and oral exams in their specialty in order to become board certified. Each of the 26 medical specialties has different requirements for practitioners to undertake continuing medical education activities.

Whilst many other disciplines result in an individual potentially impacting the health and safety of others medical professionals directly impact others and may be the only barrier between them and severe pain, disability, or even death. Accordingly, medical training is more exhaustive but also significantly more complex as every individual is unique in their symptoms, conditions, pain thresholds, and overall presentation of their condition which is further complicated by the fact that unlike engineering and other sciences the results of applying similar surgical or drug regimens may result in different outcomes, the opportunity to re-start from the beginning generally unavailable, and the tools for detailed diagnosis absent surgical intervention generally complex and expensive such as Nuclear Magnetic Resonance Imaging (NMR), X-ray Computer Aided Tomography (CMT), and Positron Emission Tomography (PET) when compared to ultrasound imaging and medical radiography.

In many instances the occurrences of particular medical conditions or combinations of medical conditions may be unusual, rare or even extremely rare. Accordingly it would be beneficial to provide medical professionals, medical schools, nursing schools, and other medical institutions with an ability to generate a wide variety of teaching, training, and examination materials within a software application and/or software system that allows the authors of such materials to access medical cases from within their own medical facility but also from other institutions thereby increasing the pool of medical cases available.

At the same time Government regulations on the privacy of confidential information may appear to initially restrict the distribution and use of patient medical records and information even within the same medical institution as such information unless expressly approved by the patient may only be used by those involved in the treatment of the individual. Accordingly, any consideration of compiling medical information for any educational use, including medical research publications, must address such regulations and ensure that the patient is not identified within the materials nor can their identity be derived. Typically considerations of legal and medical educational requirements are completely different arms within a medical institution and such considerations may become even more difficult to manage when one physician contacts another seeking content for a training program.

It would therefore be beneficial for any physician, surgeon, educator, or other educational related provider to access medical case information either locally or remotely to their institution in a manner that such regulatory requirements are managed automatically. Further, it would be beneficial for such an educational content generator to provide medical professionals with the additional tools and resources to generate, manage, track and supervise the educational process in what may due to logistical or institutional policies be increasing reliance on online teaching for initial and continuous medical education requirements. It would be therefore beneficial for medical education to therefore be based within a learning management system (LMS) or virtual learning environment (VLE) that addresses regulatory based privacy issues and educational issues which are absent within other educational environments.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art with respect to medical education and more specifically to managing patient clinical data within regulatory requirements.

In accordance with an embodiment of the invention there is provided a method comprising:
providing a database comprising at least one patient record of a plurality of patient records, each patient record relating to an individual and a medical activity associated with the patient and containing confidential information relating to the patient;
associating with each patient record of the plurality of patient records waiver information relating to a granted waiver;
establishing a profile relating to an educational activity, the profile comprising attributes relating to a medical topic; and
extracting a predetermined portion of the at least one patient record in dependence upon at least the patient records, the profile, and the waiver information wherein the predetermined portion is absent information identifying the patient.

In accordance with an embodiment of the invention there is provided a method comprising:

providing a database comprising at least one patient record of a plurality of patient records, each patient record relating to an individual and a medical activity associated with the patient and containing confidential information relating to the patient;

associating with each patient record of the plurality of patient records waiver information relating to a granted waiver;

establishing a profile relating to an educational activity from a requestor other than a provider relating to the medical activity, the profile comprising attributes relating to a medical topic;

extracting a predetermined portion of the at least one patient record in dependence upon at least the patient records and the profile wherein the predetermined portion is absent information identifying the patient; and

providing the predetermined portion of the at least one patient record to the requestor when the waiver information meets a predetermined condition.

In accordance with an embodiment of the invention there is provided a method comprising:
providing an educational activity to a plurality of users, the educational activity comprising at least one case of a plurality of cases;
monitoring the educational activity to determine at least one characteristic of a plurality of characteristics of the educational activity;
contacting the author of the educational activity when the at least one characteristic meets a predetermined condition.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a communications network supporting devices and infrastructure according to an embodiment of the invention;

FIG. 2 depicts an electronic device supporting communications with a software system and/or software application according to an embodiment of the invention;

FIG. 3 depicts a hierarchy of knowledge enabled according to a software system and/or software application according to an embodiment of the invention;

FIGS. 4A and 4B depict screenshot presented to a user relating to patient records using a software system and/or software application according to an embodiment of the invention;

FIG. 5 depicts a screenshot presented to a user relating to a patient's waiver using a software system and/or software application according to an embodiment of the invention;

FIG. 6 depicts an educational flow supported by a software system and/or software application according to an embodiment of the invention;

FIG. 7 depicts an educational environment supported by a software system and/or software application according to an embodiment of the invention;

FIG. 8 depicts a user interface presented to a member of a community supported by a software system and/or software application according to an embodiment of the invention;

FIG. 9A depicts a screenshot presented to a member of a community supported by a software system and/or software application according to an embodiment of the invention;

FIG. 9B depicts a knowledge honeycomb supported by a software system and/or software application according to an embodiment of the invention;

FIG. 10 depicts a community architecture and community interactions supported by a software system and/or software application according to an embodiment of the invention;

FIG. 11 depicts a structure of educational and testing activities for a medical institution supported by a software system and/or software application according to an embodiment of the invention;

FIG. 12 depicts a screenshot presented to a student by a software system and/or software application according to an embodiment of the invention;

FIG. 13 depicts case bank screenshot images presented to a user supported by a software system and/or software application according to an embodiment of the invention;

FIG. 14 depicts a lesson screenshot presented to a user by a software system and/or software application according to an embodiment of the invention;

FIG. 15 depicts a case bank list presented to a user accessing a software system and/or software application according to an embodiment of the invention;

FIG. 16 depicts a user interface screenshot for a user selecting an activity using a software system and/or software application according to an embodiment of the invention;

FIG. 17 depicts an examination reporting screenshot image presented to a user of a software system and/or software application according to an embodiment of the invention;

FIG. 18 depicts an examination reporting screenshot image presented to a user of a software system and/or software application according to an embodiment of the invention;

FIG. 19 depicts an exemplary process flow for a user accessing a software system and/or software application according to an embodiment of the invention;

FIG. 20 depicts an exemplary process flow for a user adding cases to software system and/or software application according to an embodiment of the invention;

FIG. 21 depicts an exemplary process flow for a user compiling an activity using a software system and/or software application according to an embodiment of the invention;

FIG. 22 depicts an exemplary process flow for a user compiling an activity using a software system and/or software application according to an embodiment of the invention;

FIG. 23 depicts patient cross-referencing and identity restriction using a software system and/or software application according to an embodiment of the invention;

FIG. 24 depicts an exemplary process flow according for crowd sourcing an examination according to an embodiment of the invention;

FIG. 25 depicts an exemplary flow diagram for case content generation according to an embodiment of the invention; and

FIG. 26 depicts an exemplary user interface screenshot for a user upon a mobile device using a software system and/or software application according to an embodiment of the invention.

### DETAILED DESCRIPTION

The present invention is directed to medical education and more specifically to managing patient clinical data within regulatory requirements.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure may refer to, but is not limited to, a wireless device used for communications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure may refer to, but is not limited to, an electronic device used for communications that exploits interconnection to a fixed location electrical utility outlet or other power source upon which it is dependent. This includes devices with wired and wireless communications interfaces including, but not limited to, personal computers (PCs), gaming consoles, laptop computers, televisions, kiosks, display terminals and set-top boxes for satellite and/or cable based services.

A “network operator/service provider” as used herein may refer to, but is not limited to, a telephone or other company that provides services for mobile phone subscribers including voice, text, and Internet; telephone or other company that provides services for subscribers including but not limited to voice, text, Voice-over-IP, and Internet; a telephone, cable or other company that provides wireless access to local area, metropolitan area, and long-haul networks for data, text, Internet, and other traffic or communication sessions; etc.

A “user,” as used herein and through this disclosure refers to, but is not limited to, a person or device that utilizes an education software application and/or software system according to embodiments of the invention, either as a student, educator, administrator, or other user. A “student” as used herein and through this disclosure refers to, but is not limited to, a person or individual who exploits the education software application and/or software system in order to perform a learning activity which may for example be prior to receiving a qualification or after qualification as part of continuous education requirements or personal desire to continue learning. A “patient,” as used herein and through this disclosure refers to, but is not limited to, a person or individual whose medical records are stored at least in part within a medical based education software application and/or software system according to embodiments of the invention, wherein the medical records relate to medical activities relating to the patient within a medical facility. A “hospital” or “medical facility” as used herein may refer to a facility, institution, group, or organization that has registered with a software system and/or software application according to embodiments of the invention for the purposes of providing educational services with respect to medical education or issuing/publishing research materials relating to medical practices and treatments to advance the status of knowledge within the medical community overall.

An “electronic medical record” (EMR) or “electronic health record” (EHR) as used herein and through this disclosure refers to, but is not limited to, a computerized medical record created in an organization that delivers medical care, such as a hospital or physician's office. Whilst at this point in time EMR/EHR records tend to be a part of a local stand-alone health information system that allows storage, retrieval and modification of records it would be understood by one skilled in the art that such EMR/EHR records may be part of a city, provincial, state, national or international system allowing medical personnel access to varying aspects of an individual's EMR/EHR according to their requirements at that point in time. A “case” as used herein and through this disclosure refers to, but is not limited to, a computerized medical record created in an organization that delivers medical care for the purposes of delivering educational development or training According to embodiments of the invention a case may be generated, stored, retrieved, and modified by medical personnel using a software system and/or software application. Reference to “a software system and/or software application” as used herein and through this disclosure refers to, but is not limited to, a software system and/or software application which may be distributed, purchased, sold, and/or licensed to users and/or hospitals according to embodiments of the invention. Examples of such software solutions including “iMed Teach” and “iMed Community” as developed and marketed by iMed Media of Ontario, Canada. However, it would be evident that multiple commercial software products may be active within one or more markets.

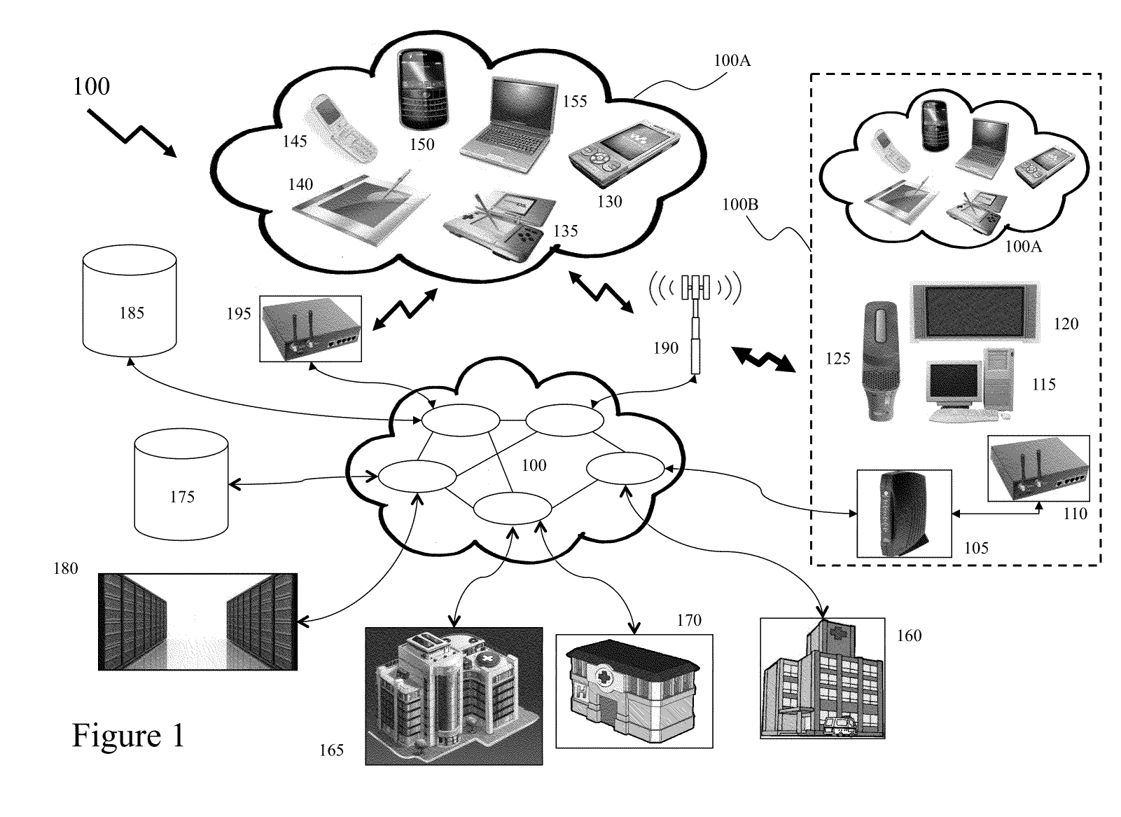

FIG. 1 depicts a network supporting communications and interactions between devices connected to the network according to embodiments of the invention with geographically separate first and second user groups 100A and 100B respectively interfacing to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second wireless access points (AP) 195 and 110 respectively which provide Wi-Fi cells for first and second user groups 100A and 100B respectively.

Within the cell associated with first AP 195 the first group of users 100A may employ a variety of portable electronic devices (PEDs) including for example, laptop computer 155, portable gaming console 135, tablet computer 140, smartphone 150, cellular telephone 145 as well as portable multimedia player 130. Within the cell associated with second AP 110 the second group of users 100B may employ a variety of PEDs such as those identified with first group of users 100A identified above including for example, laptop computer 155, portable gaming console 135, tablet computer 140, smartphone 150, cellular telephone 145 as well as portable multimedia player 130. Additionally users within the second group of users 100B may employ a variety of fixed electronic devices (FEDs) including for example gaming console 125, personal computer 115 and wireless/Internet enabled television 120. These FEDs may be connected to network 100 via a cable modem 105 although other interfaces including but not limited to digital subscriber access (for example DS1, DS3 etc) and satellite set-top box.

Also connected to the network 100 is cell tower 190 that provides, for example, cellular GSM (Global System for Mobile Communications) telephony services as well as 3G and 4G evolved services with enhanced data transport support. Cell tower 190 proves coverage in the exemplary embodiment to first and second user groups 100A and 100B. Alternatively the first and second user groups 100A and 100B may be geographically disparate and access the network 100 through multiple cell towers, not shown for clarity, distributed geographically by the network operator or operators. Accordingly, the first and second user groups 100A and 100B may according to their particular communications interfaces and PEDs/FEDs communicate to the network 100 through one or more communications standards such as, for example, IEEE 802.3, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VoIP and Internet access.

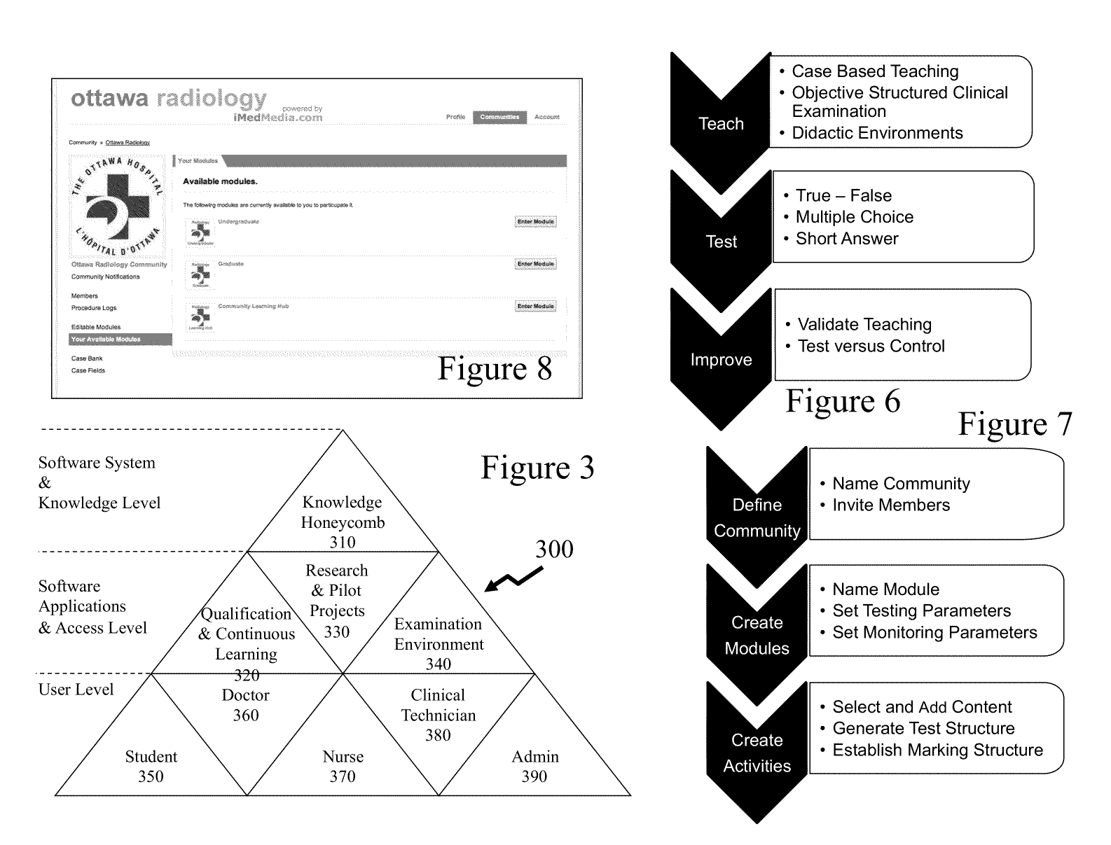

Also connected to the network 100 are first to third medical facilities 160 through 180 respectively which employ software system and/or software application to provide educational and publication activities according to embodiments of the invention relating to medical information. Also connected to network 100 are first and second servers 175 and 185 respectively which host according to embodiment of the inventions multiple services associated with a provider of the software system(s) and software application(s) associated with embodiments of the invention, but not limited to, dictionaries, case databases, lesson databases, examination databases, administration databases, EMR/EHR databases, patient waiver databases, and software applications for download to fixed and portable electronic devices to support the software system and/or software application. First and second servers 175 and 185 respectively may also host for example other Internet services such as a search engine, financial services, third party applications and other Internet based services. It would also be evident that multiple other servers may be employed such as, for example, associated with each of the first to third medical facilities 160 through 180 respectively wherein these locally store and support the software system and/or software application for their respective medical facility as well as supporting communications to first and second servers 175 and 185 in order to provide access to content from other facilities according to the restrictions as will be discussed below in respect of embodiments of the invention with respect to FIGS. 3 through 23.

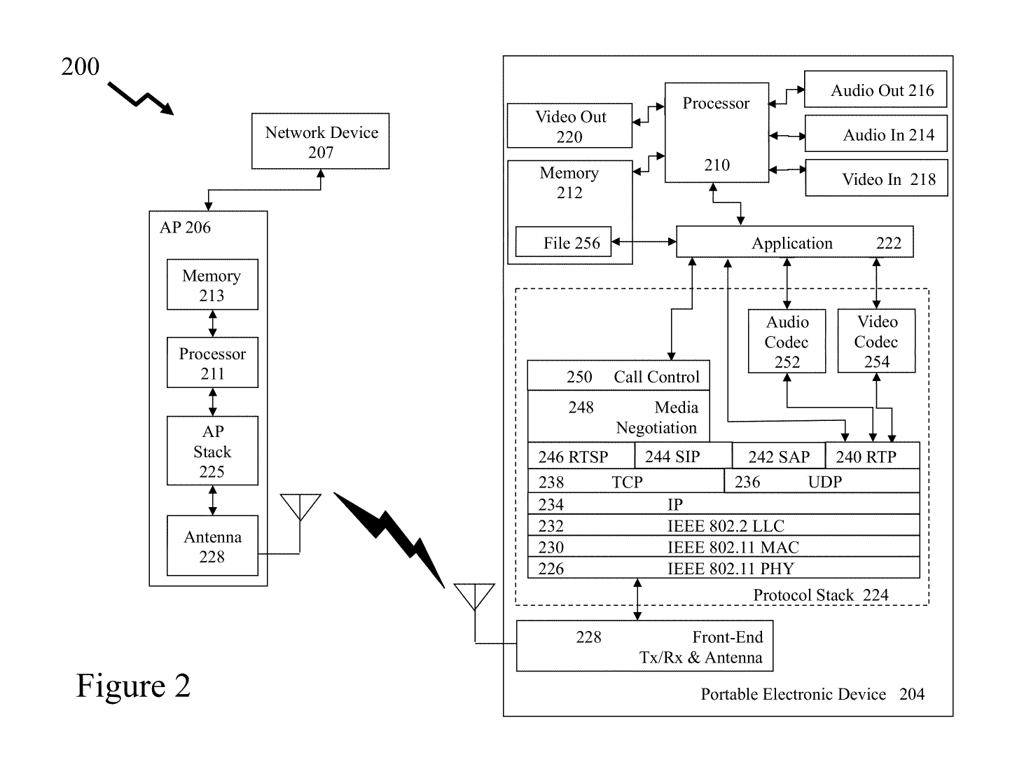

Referring to FIG. 2 there is depicted a portable electronic device (PED) 204, supporting communications and interactions according to embodiments of the invention. Also depicted within the PED 204 is the protocol architecture as part of a simplified functional diagram of a system 200 that includes a portable electronic device (PED) 204, such as a smartphone 155, an access point (AP) 206, such as first Wi-Fi AP 110, and one or more network devices 207, such as communication servers, streaming media servers, and routers for example such as first and second servers 175 and 185 respectively. Network devices 207 may be coupled to AP 206 via any combination of networks, wired, wireless and/or optical communication links such as discussed above in respect of FIG. 1. The PED 204 includes one or more processors 210 and a memory 212 coupled to processor(s) 210. AP 206 also includes one or more processors 211 and a memory 213 coupled to processor(s) 211. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

PED 204 may include an audio input element 214, for example a microphone, and an audio output element 216, for example, a speaker, coupled to any of processors 210. PED 204 may include a video input element 218, for example, a video camera, and a video output element 220, for example an LCD display, coupled to any of processors 210. PED 204 includes one or more applications 222 that are typically stored in memory 212 and are executable by any combination of processors 210. PED 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the PED 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. It would also be evident to one skilled in the art that multiple FEDs essentially have s a similar structure to PED 204, such as for example gaming consoles, PCs, laptop computers etc and that the IEEE 802.11-compatible PHY module 226 and IEEE 802.11-compatible MAC module 230 may be replaced and/or augmented with other PHY and MAC modules according to one or more other standards supported by the FED. In some instances Front-End Tx/Rx & Antenna 228 may be not present and a physical media interface coupling provided such as for example an Ethernet port whilst in others the FED may wirelessly couple to a router.

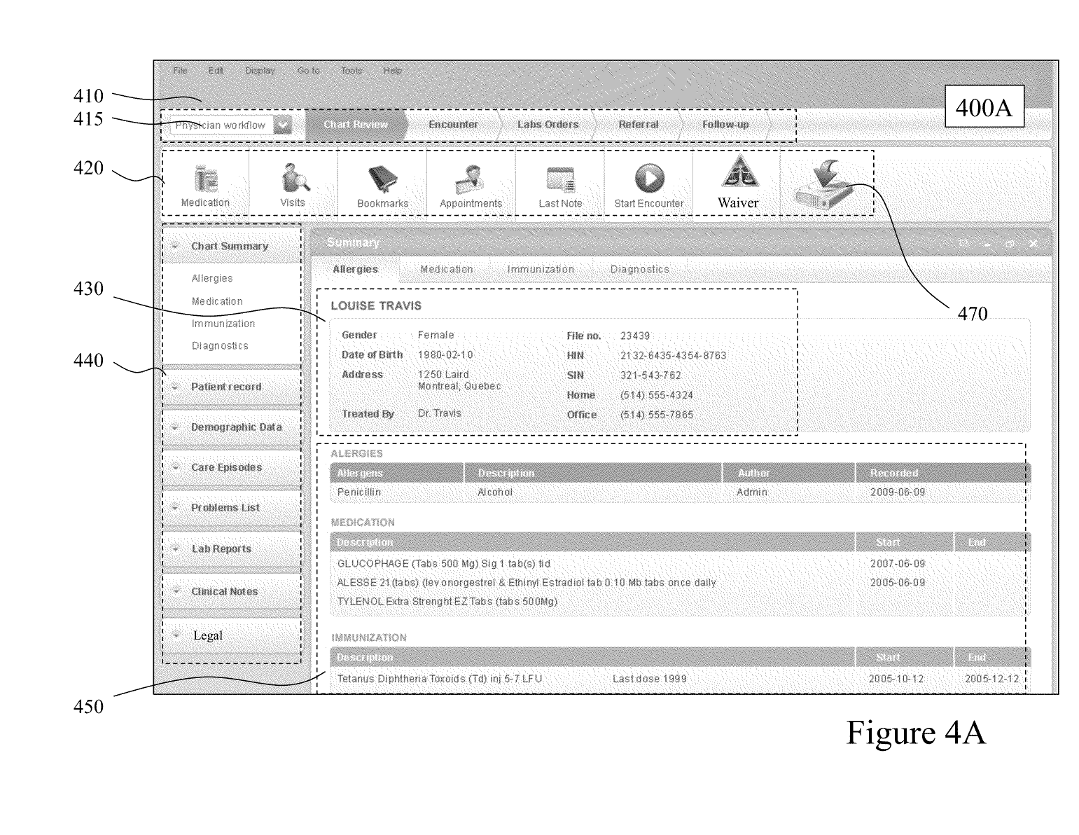

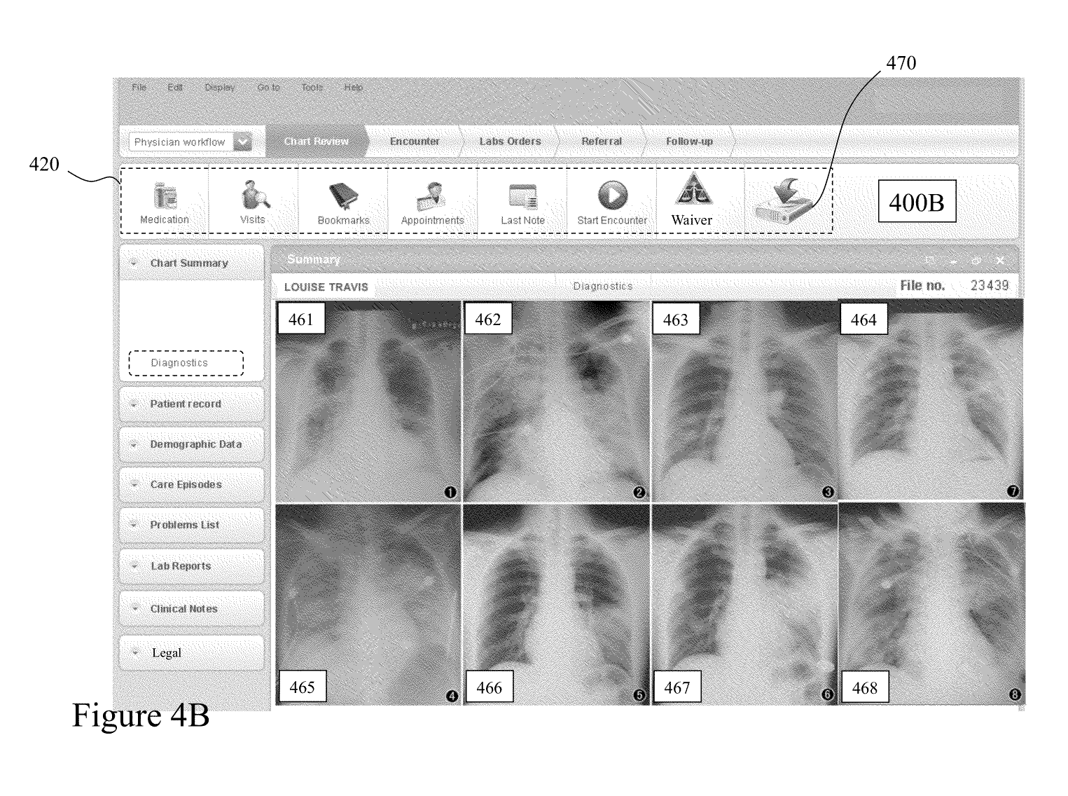

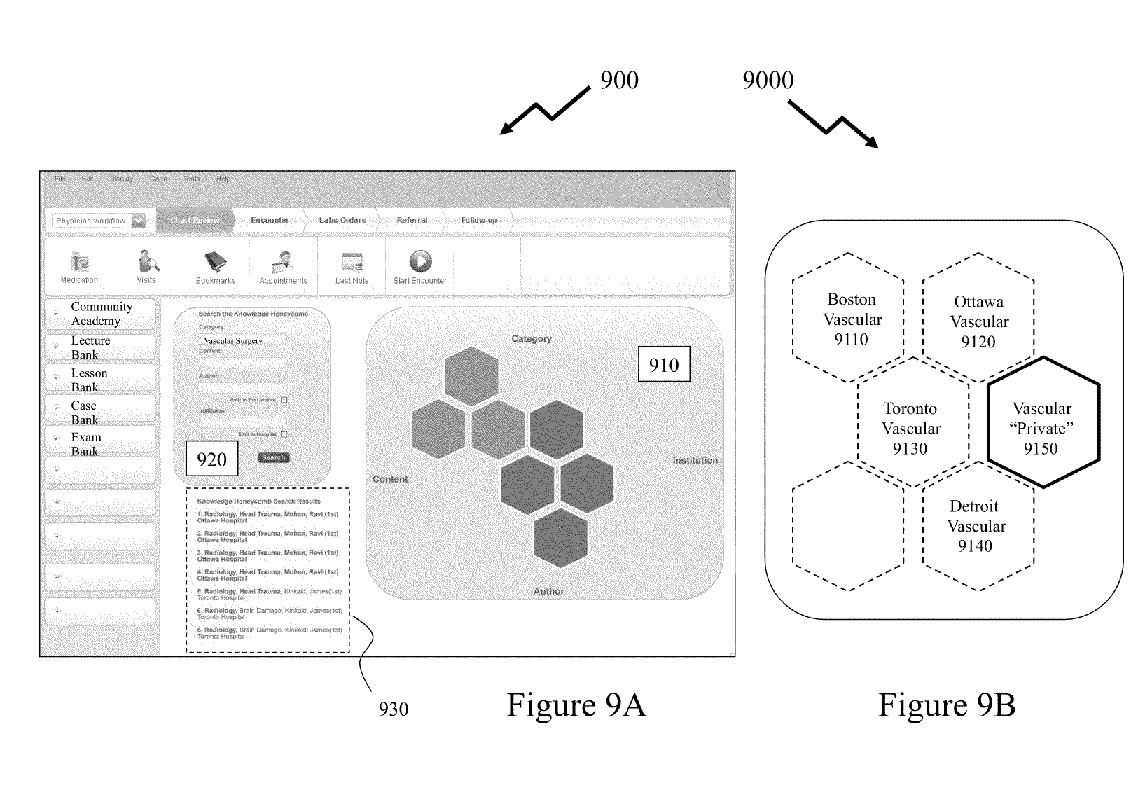

FIG. 3 depicts a hierarchy of knowledge enabled according to a software system and/or software application according to embodiments of the invention. Accordingly a knowledge honeycomb 310 is supported by the software system and/or software application such that cases, lessons, examinations, etc may be accessed by users according to their access rights either within their own facility or across other facilities such as depicted figuratively in FIG. 9B below. Such users including for example students 350, doctors 360, nurses 370, clinical technicians 370 and administrators 390 who typically access the knowledge honeycomb 310 through one or more applications/access levels which may include for example Qualification & Continuous Learning 320, Research and Pilot Projects 330, and Examination Environment 340. Accordingly a Fellow or Resident within the user group doctors 360 may establish an examination within the examination environment 340 by accessing knowledge honeycomb 310 to retrieve an examination already completed by another facility in respect of their educational programs or may generate a new examination using cases from within their own facility and/or other facilities which may require that the cases are completed within the examination by students and/or other documents. Accordingly a student 360 may access the knowledge honeycomb 310 in terms of accessing lessons, taking examinations, and generating case content. Such options and interactions will be discussed below in respect of FIGS. 4 through 23.

FIG. 4A depicts a first screenshot 400A presented to a user relating to patient records using a software system and/or software application according to embodiments of the invention. According to some embodiments of the invention software system and/or software application may contain itself detailed EMR/EHR records relating to patients or may access a commercial EMR/EHR software system and/or software application and display content from this other application. Alternatively software system and/or software application may display only predetermined portions of the EMR/EHR records of patients. As depicted first screenshot 400A comprises toolbar 410 providing options to the user according to their access rights. For example a resident may have access to multiple workflows such as examination, physician, and case whilst a student may only have access to a single workflow. The current workflow active is presented in workflow window 415 within toolbar 410 alongside with any tabs appropriate to the workflow selected and the overall feature set of software system and/or software application.

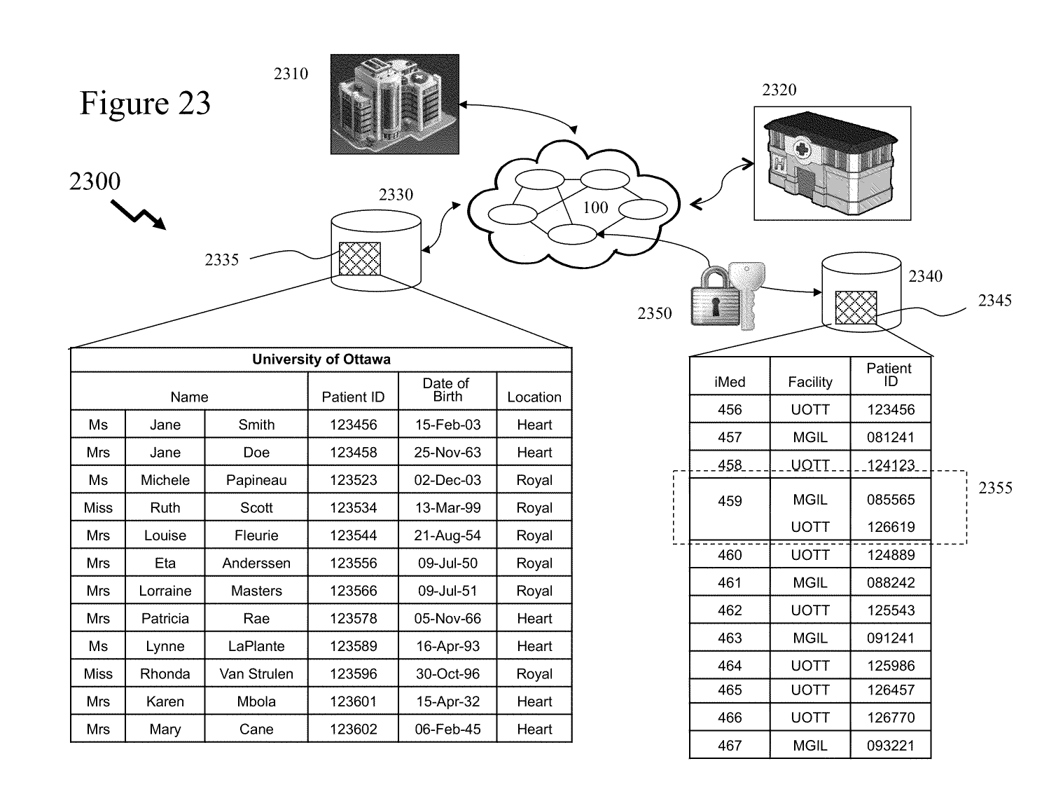

Also depicted within first screenshot 400A are selection buttons 420 allowing the user to see aspects of the medical record of the patient including for example medication, visits, appointments, last note, waiver as well as starting an encounter with the patient to obtain additional information not present within their medical record or as will be described below to obtain a missing or new waiver with respect to usage data relating to the patient. Within selection buttons 420 is Export 470 which allows the user to export selected content from the patient record to a case file. As described below in respect FIG. 23 case files created within software system and/or software application are stored with unique identifiers that are independent of data relating to the patient such that accessing a case from within a lesson, examination, or other aspect of software system and/or software application does not provide details of the patient. However, should cross-reference be required this is stored within a separate secure file.

Now referring to FIG. 4B there is depicted a second screenshot 400B wherein a user accessing software system and/or software application has accessed the diagnostics for the patient “Louise Travis” whose patient records are presented in FIG. 4A described above. As shown second screenshot 400B contains first to eighth X-ray images 461 through 468 are depicted. Accordingly, as with first screenshot 400A the user may select one or more items within the second screenshot and export these to a case file through action of Export 470 icon within the selection buttons 420 toolbar. Selection of content within screenshots 400A and 400B of the software system and/or software application system may be made according to one or more of the techniques within the prior art. It would also be evident that in some instances content may be tagged such that when transmitted to the user during an online lesson or examination for example that they are aware the content has high resolution and/or high dynamic range content which is unsuitable for viewing on some PED devices and best suited to display upon certain PEDs and/or FEDs.

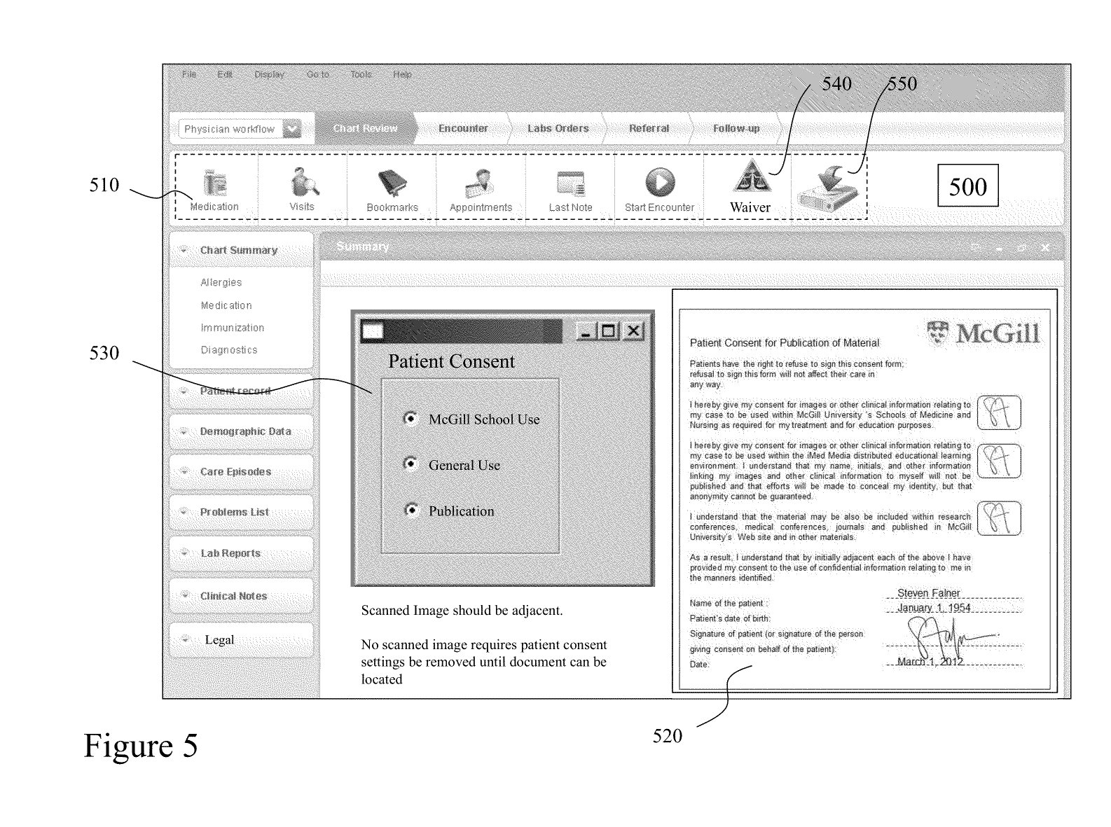

Now referring to FIG. 5 there is depicted a screenshot 500 presented to a user relating to a patient's waiver using a software system and/or software application according to embodiments of the invention such as software system and/or software application. Accordingly the user has accessed the Waiver section for the current patient via Waiver 540 icon within selection buttons 510 toolbar presented to the user. Accordingly, the screenshot 500 displays the patient consent information relating to their medical records which in this instance are classified in three categories termed “McGill School Use”, “General Use”, and “Publication” as listed within consent list 530. In this instance the patient has provided consent in all three categories and confirmation of this is evident to the user by image 520 that presents a scanned image of the consent form executed by the patient relating to their medical engagement with the McGill University School of Medicine in this instance. According to this embodiment of the invention “McGill School Use” relates to the patient approving use of medical data relating to their condition/treatment etc being used only within educational, training, and examination materials of the McGill University School of Medicine.

“General Use” relates to the patient allowing use of this medical data within educational, training, and examination materials of other institutions licensing/acquiring the software system and/or software application who may access educational, training, and examination materials developed by McGill University or as established within a case study through the knowledge honeycomb established by software system and/or software application. It would be evident to one skilled in the art that the waiver relating to some patients, for example children, the elderly, the mentally ill, etc may be signed by a third party other than the patient themselves. Such third parties including for example parents, guardians, and Court appointed trustees.

In some instances a waiver may have a time limit attached to it within the software system and/or software application due to a variety of factors including, but not limited to, a patient ceasing to be a minor within a particular jurisdiction and requiring them to execute a waiver themselves as a legal adult, a patient passing a regulatory age limit, a patient being released from Court appointed supervision or trustee, and a patient being certified mentally competent.

Referring to FIG. 6 there is depicted an educational flow supported by a software system and/or software application according to embodiments of the invention wherein the flow presents the well known concepts of teach, test, and improve. In teach one or more techniques within the prior art such as Case based teaching, Objected Structured Clinical Examination (OSCE), and Didactic environments may be used to provide the knowledge that a medical educational facility considers appropriate to those registered with it from employees through to students. Subsequently that knowledge acquisition is tested within a testing stage that may employ one or more formats including for example True/False, multiple choice and short answer. Next in improve feedback is provided both to the educators and the students in order to improve the educational process, validate results, and encourage further development. Within the medical arena many aspects of the diagnosis process could be described as subjective in that students for example view an X-ray image, CAT scan image, mammogram, MRI image, heart monitor output or other data derived from one or more patients and must make an interpretation of the data to establish a diagnosis in conjunction with no, part or full patient histories/profiles and therefrom potentially a recommended course of treatment. In such instances if every student misses a critical element then potentially there is an issue with the materials provided in that an essential clue or indicator is not present despite the educator's belief it is.

Accordingly referring to FIG. 7 there is depicted an educational environment supported by a software system and/or software application according to embodiments of the invention mapped to the same essential educational process described above in respect of FIG. 6. Accordingly teaching is achieved through the establishment of educational communities and the members within being provided teaching/evaluation materials. These materials being established within software system and/or software application by creation of one or more modules and establishing associated with each a set of testing and/or monitoring parameters. Next within each module activities are created by the selection of content, including cases, generating the structure of the activity and then establishing a marking structure for the activity. The generation, execution, and maintenance of these different elements, namely communities, modules and activities, being described below in respect of FIGS. 8 through 23.

Referring to FIG. 8 depicts a user interface presented to a member of a community supported by a software system and/or software application according to embodiments of the invention. In this instance the user has logged into the Ottawa Radiology community of The Ottawa Hospital wherein the user is presented with available modules within Undergraduate, Graduate and Community Learning Hub based upon their profile. For example, an administrator within the Ottawa Radiology community might be presented with only the Community Learning Hub, a student the Undergraduate and Community Learning Hub modules and a fellow all three modules. Similarly, a fellow upon entering a module, e.g. Community Learning Hub, may be provided with different options to an administrator in that a fellow may for example author content, administer tests etc whereas the administrator is only able to partake in an educational activity and undertake an examination. Controlling access to users based upon their profile and user access credentials may be achieved using any one of the prior art solutions or a combination thereof.

Now referring to FIG. 9A there is depicted a screenshot 900 presented to a member of a community supported by a software system and/or software application according to embodiments of the invention. In this screenshot 900 a physician workflow is presented wherein the user is searching within the knowledge honeycomb based upon selections made in entry screen 920 thereby generating result list 930 and honeycomb 910 to visually depict the returned results to the user. An exemplary knowledge honeycomb being displayed in FIG. 9B with honeycomb 9000 as generated with a software system and/or software application according to embodiments of the invention. Honeycomb 9000 in this instance displays centrally Toronto Vascular 9130, to the right Vascular “Private” 9150 as that community relates to the institution, below Detroit Vascular 9140 due to the previous location of the author at that institution so content within that community may have been authored by or be familiar to the user, and above Boston Vascular 9110 and Ottawa Vascular 9120 being associated communities within the category of “Vascular Surgery.” Accordingly honeycombs 910 and 9000 provide a visual depiction of the content within the knowledge honeycomb support by software system and/or software application.

According to the rights established for a user within a community within a knowledge honeycomb they may share established content with permission from the originating community, upload content to a “private” community, review requests for content from another community, establish options to share or not share content generated under their authorship, and established editing rights for content generated under their authorship. In the latter example a user may release an educational activity, lesson, they have generated to a colleague they know well with edit rights or they may release to an unknown user at another institution without edit rights so that the user in this instance uses the educational activity as authored. It would be evident to one skilled in the art that protection of activities, lessons, exams, cases generated within software system and/or software application may be protected with one or more encryption and protection schemes known in the prior art for preventing the unauthorised distribution, copying, editing, deletion, and amendment of content within electronic content of varying formats including, but not limited to, documents, audiovisual content, images, computer generated content, and handwritten content.

Content within open communities such as Toronto Vascular 9130, Detroit Vascular 9140, Boston Vascular 9110 and Ottawa Vascular 9120 may be searched by members of each of these communities to identify material(s) of interest. However, content within closed communities such as Vascular “Private” 9150 may not be searched by members of other communities but may be searched by members of that specific community. As Vascular “Private” 9150 appears within the knowledge honeycomb 9000 resulting from the user search a member of an open community, e.g. Toronto Vascular 9130 may contact one or more members of the Vascular “Private” 9150 community designated as contacts to inquire whether material(s) exist that relate to their search.

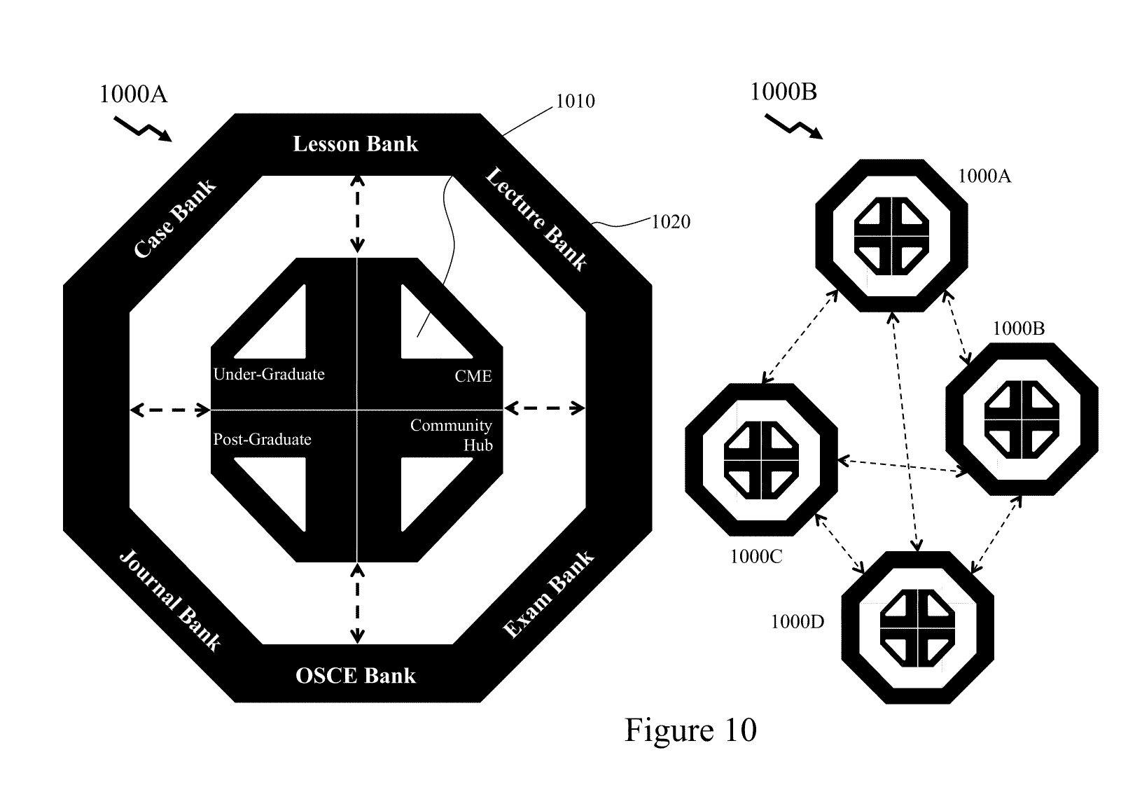

Referring to FIG. 10 there are depicted a Community architecture 1000A and Community interactions map 1000B supported by a software system and/or software application according to embodiments of the invention. Community architecture 1000A depicts a community as comprising an outer ring 1020 comprising materials generated and inner core 1010 comprising members of the community and the activities they undertake. In the outer ring 1020 at the top are a Case Bank representing those cases entered/generated by the Community wherein each case relates to a patient for whom an aspect of their medical condition, diagnosis, or treatment merited their inclusion within the specialty or interest area of the Community; a Lesson Bank representing those lessons generated by one or members of the Community relating to a topic of educational benefit to one or more community groups and compiled typically using one or more cases from the Case Bank; and a Lecture Bank representing a lecture generated by one or more members of the Community relating to a topic of educational benefit to one or more community groups and compiled typically from one of more lessons.

In the outer ring 1020 at the bottom are a Journal Bank representing an area for Community members to store work in progress, notes, and other aspects of their activities relating to the Community; an OCSE Bank representing a library of OCSE stations in virtual form allowing students to rotate through them wherein OCSE stations are established using cases within the Case Bank; and an Exam Bank comprising a library of examinations established by senior members of the community, e.g. Fellows or Residents, for testing students within the community, e.g. undergraduate and graduate;

It would be evident to one skilled in the art that the different banks, identified as Case, Lesson, Lecture, Journal, OCSE, and Exam, within the outer ring 1020 represent examples of those that might be provided within a Community. Others may be added and some restricted according to the particular Community. Within the inner core 1010 there are depicted members of the Community which are denoted as Under-Graduate, Post-Graduate, and Community Hub together with Continuing Medical Education (CME) which may include under-graduates, post-graduates, fellows, residents as well as clinical technicians and administrators. Members within the Community undertake different modules comprising lessons and/or lectures together with Examinations and OSCE stations.

Within Community interactions map 1000B first to fourth Communities 1000A through 1000D are depicted representing different Communities such as described above in respect of Toronto Vascular 9130, Detroit Vascular 9140, Boston Vascular 9110, Ottawa Vascular 9120 and Vascular “Private” 9150. Members within each Community according to their rights may search within other Communities related to theirs. Accordingly, a member of a vascular Community such as those described in respect of FIG. 9B may search within other vascular Communities but not within other, such as oncology, thorasic surgery, and otolaryngology. However, some members of a Community, such as Department Heads, Senior Administrators may have access across multiple Community areas.

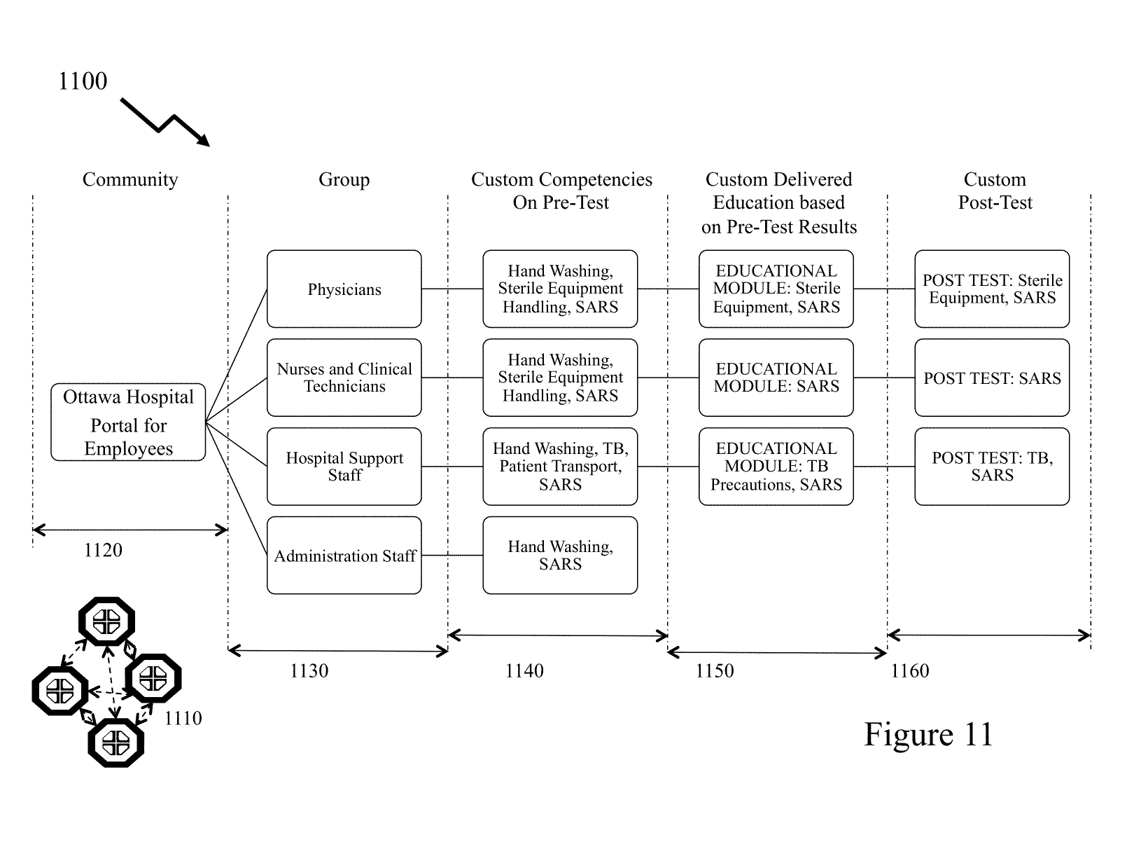

Referring to FIG. 11 depicts a structure 1100 of educational and testing activities for a medical institution supported by a software system and/or software application according to embodiments of the invention. As depicted a Community 1120, Ottawa Hospital, provides a portal for employees wherein represents Community 1120 represents one element of a knowledge honeycomb. Within the Community 1120 are a plurality of Groups 1130, depicted in this instance as Physicians, Nurses & Clinical Technicians, Hospital Support Staff, and Administration Staff Members of one or more of these Groups 1130 may be members of other Communities 1120 within the knowledge honeycomb 1110 that relate to Community 1120 or in the instances of Physicians, Nurses, and Clinical Technicians may relate to one or more specialties they practice within.

Each Group 1130 has associated one or more requirements, which for Physicians are identified as Sterile Equipment and Severe Acute Respiratory Syndrome (SARS). Accordingly each Physician is assessed through a series of Custom Competency Pre-Tests 1140 addressing the requirements which are identified as Hand Washing, Sterile Equipment Handling and SARS. Based upon the results for a Physician they are provided with specific educational modules within Custom Delivered Education 1150 which are derived in dependence upon their pre-test results. The Physician upon completion of the Custom Delivered Education 1150 is then tested within Custom Post-Test 1160 to determine their acquisition of knowledge from the Custom Delivered Education 1150. Each Group 1130 has therefore their own Custom Competency Pre-tests 1140, Custom Delivered Education 1150, and Custom Post-Test 1160. Whilst Community 1120 relates to all employees within the Ottawa Hospital some members as discussed above will be members of other communities relating to their specialties and including other groups not identified for sake of clarity in FIG. 11 such as under-graduates and post-graduates where the medical facility is an educational medical institution.

Accordingly, embodiments of the invention with the software system and/or software application may be employed across a wide variety of establishments linked by a common overall area, e.g. medicine. It would be evident that in some instances a knowledge honeycomb may cross disciplinary boundaries. For example some members of a cardiac community may also be members of a micromechanical device community due to the common overlap of micro-fluidics, control electronics, etc. in cardiac pacemakers in humans with cardiac pacemakers in veterinary science or microfluidic delivery systems for pharmaceuticals.

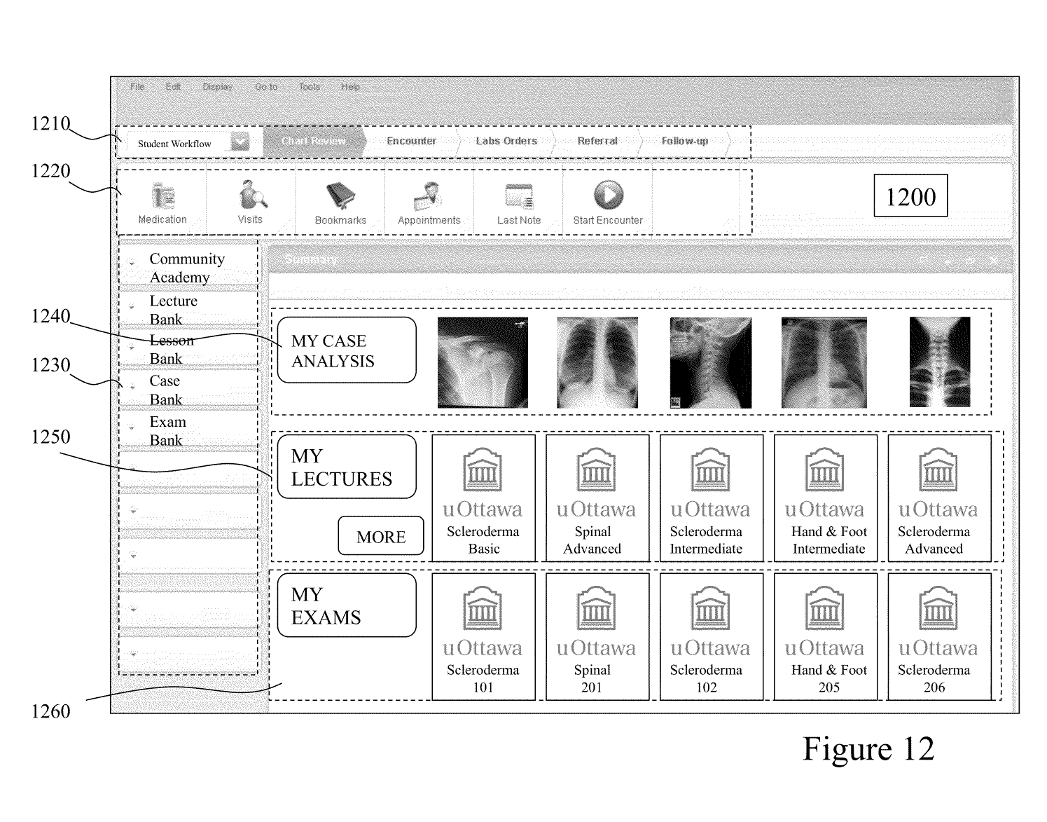

Now referring to FIG. 12 there is depicted an exemplary screenshot 1200 presented to a student member by a software system and/or software application according to an embodiment of the invention. According a student has entered the software system and/or software application and is presented with Student Workflow toolbar 1210 thereby also presenting member workflow 1220 allowing the user to schedule aspects of their activities including for example visits, bookmarks, appointments, notes and starting encounters. List 1230 on the left hand side allows the student member to access multiple aspects of the specific Community they are currently within including a Community Academy, Lecture Bank, Lesson Bank, Case Bank, and Exam Bank. According to the student member's status with the institution or institutions providing the Community these selections provide differing degrees of content to the student member. Also depicted within screenshot 1200 are three areas relating to “My Case Analysis” 1240, “My Lectures” 1250, and “My Exams” 1260.

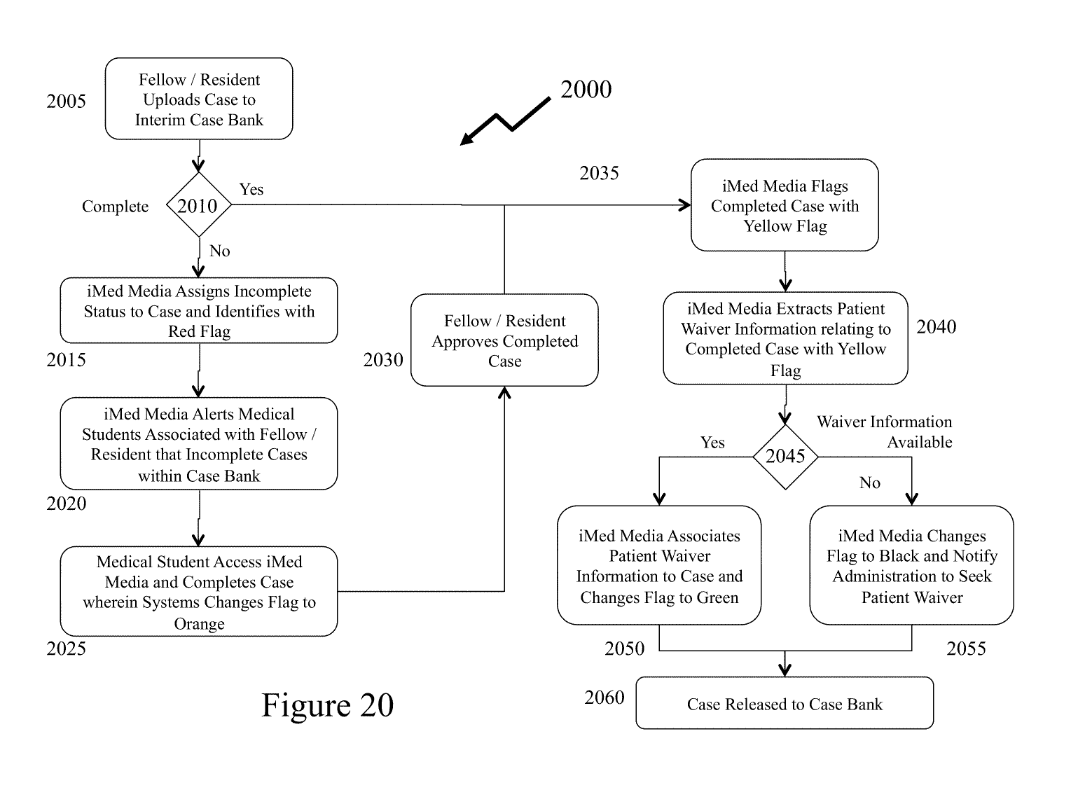

“My Case Analysis” 1240 contains cases which another member of the Community, e.g. a Resident or Fellow, has established as to be included within the Case Bank of the Community but are to be populated partially or fully by a student rather than by the Fellow or Resident for example. Such an approach to populating Cases within the Case Bank being described below in respect of the process flow in FIG. 20. “My Lectures” 1250 contains virtual learning lectures, which may comprise one or more lessons, relating to the student member. In this instance the student member has lectures identified relating to Scleroderma (Basic, Intermediate and Advanced), Spinal (Advanced), and Hand and Foot (Intermediate) together with an indication that more lectures exist which would be accessed by selecting the “More’ icon or within the “My Lectures” 1250 area. Similarly, the student member is presented with examinations they have to complete within “My Exams” 1260 which are shown as Scleroderma (101, 201, and 206), Spinal (201), and Hand and Foot (205).

It would be evident that the contents displayed to the student member within each of “My Case Analysis” 1240, “My Lectures” 1250, and “My Exams” 1260 would change as activities within each are completed and they progress through their education. Others such as graduates, Residents, Fellows, etc may have similar workspaces within software system and/or software application relating to continuous learning activities or reviewing research materials and activities within their arena. Such research materials may arise for example from the Research & Pilot Projects 330 level within the knowledge pyramid presented in FIG. 3 above.

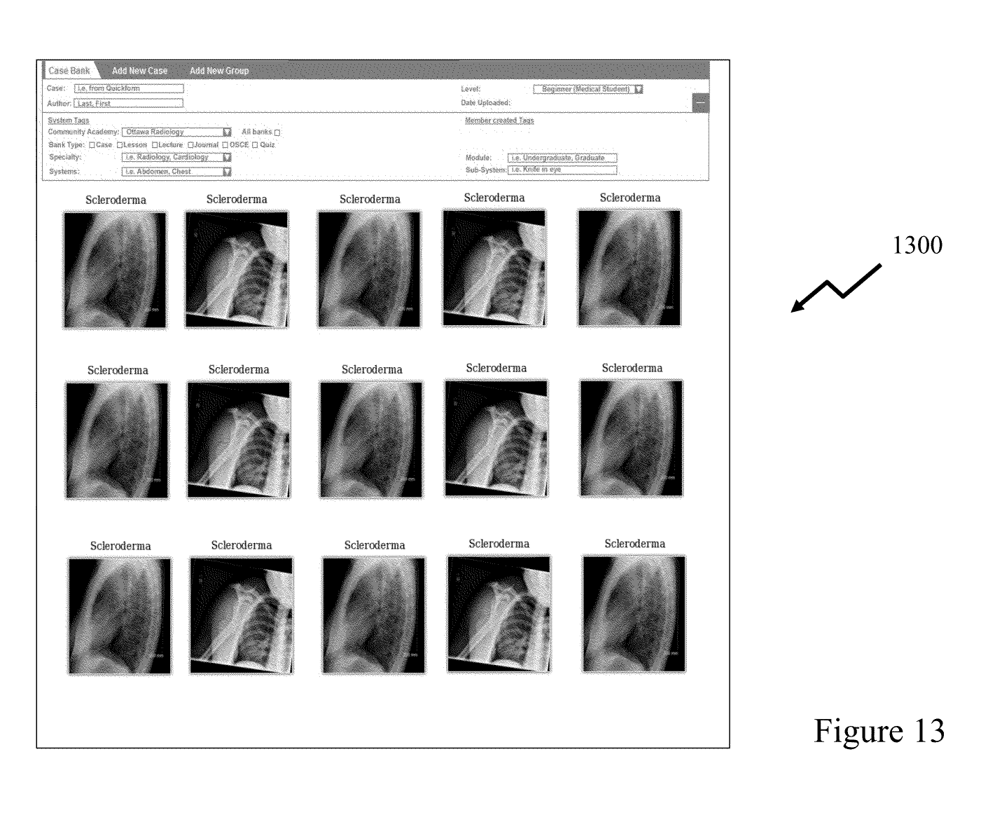

Referring to FIG. 13 depicts screenshot image 1300 presented to a user supported by a software system and/or software application according to an embodiment of the invention. First case bank screenshot image 1300 represents images from cases relating to Scleroderma within the Ottawa Radiology Community academy at Beginner (Medical Student) level. Options within the software system and/or software application in this embodiment allow filtering by one or more filters including case, author, level, Community, Bank type, Specialty, Systems, Module and Sub-System. Accordingly selecting cases within a Community may be refined with multiple options. It would be evident to one skilled in the art that other filtering options exist and others may be removed without departing from the scope of the invention. Some filters may be text entry, drop-down dialogs, and graphical selections for example as well as using others known to one skilled in the art.

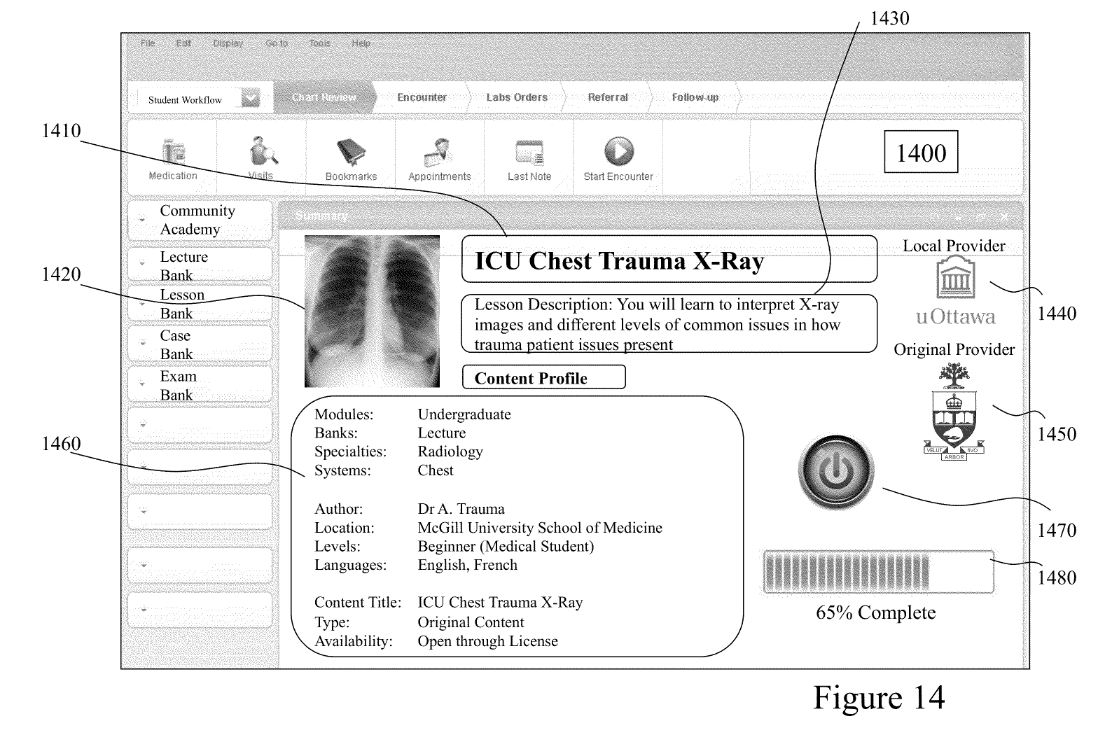

Now referring to FIG. 14 there is depicted an activity screenshot 1400 presented to a user by a software system and/or software application according to an embodiment of the invention. Within activity screenshot 1400 a student member has accessed “ICU Chest Trauma X-Ray” 1410 and is presented with a description of the activity in Description 1430 and an associated image 1420. Also depicted are the student's local provider of the activity 1440, in this instance the University of Ottawa, and the originating provider 1450, depicted as university of Toronto. Overview 1460 provides information relating to the activity 1440 such as Modules (Undergraduate), Banks (Lecture), Specialties (Radiology), and Systems (Chest). Also presented are details of the author(s), their location, the level of the activity and the languages supported together with the title of the activity, the type, and the activities availability. Subsequently, the user enters the activity by selecting start icon 1470 and is presented subsequently upon re-accessing the activity with progress bar 1480 that indicates how far they have progressed within the activity.

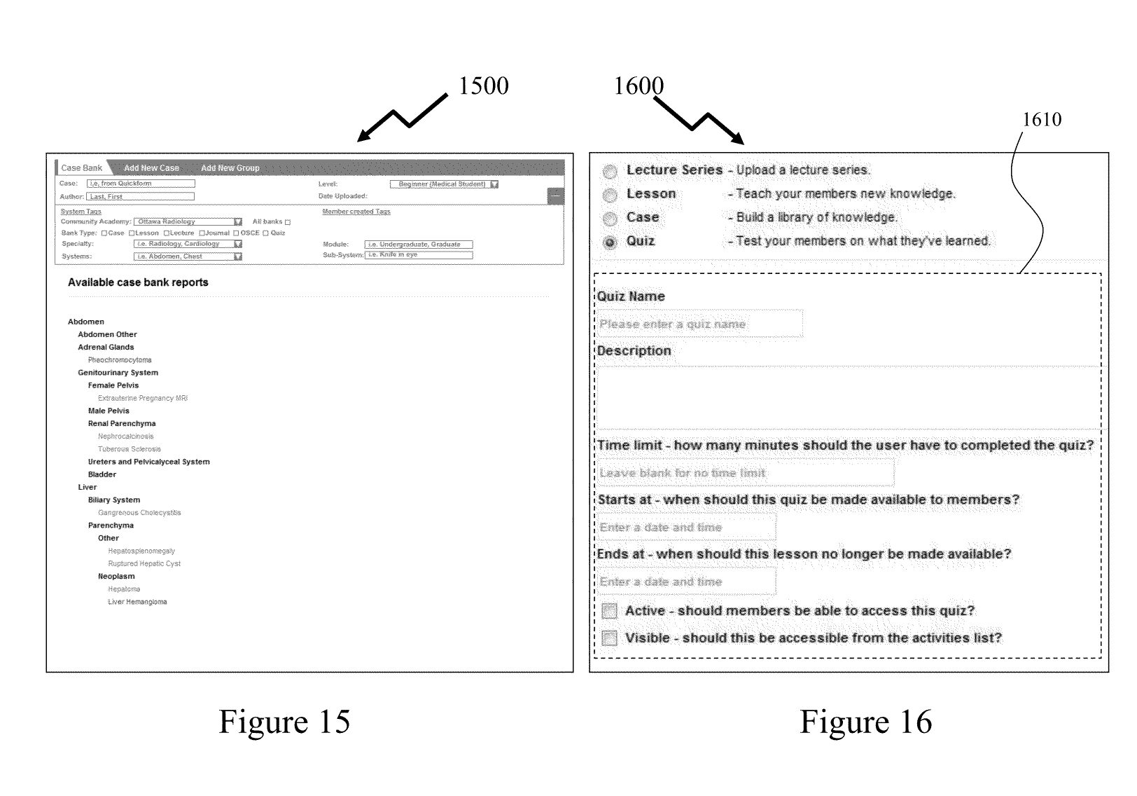

Referring to FIG. 15 there is depicted a case bank list 1500 which may be presented to a user accessing a software system and/or software application according to an embodiment of the invention. Case bank list 1500 presents to a creator (author) with a list of available case bank reports from which to create a lesson/lecture or other activity. According to other embodiments of the invention each available case bank report may have listed adjacent to it icons relating to the quantity of cases within a category, the sources of the content, and whether any content is restricted through issues including but not limited to, absence of patient waivers, being within restricted communities, age, and limited patient volumes making identification of patient(s) statistically likely. For example, an event occurring at the rate of 1 per 250,000 may be easily associated with a patient where it is known that an associated Community has for example only 50,000 individuals. As such that Community will statistically only have 1 patient such that irrespective of security measures within the software system and/or software application system a member of another Community may identify the patient.

Now referring to FIG. 16 there is depicted a user interface 1600 for a user selecting an activity using a software system and/or software application according to an embodiment of the invention. As shown the user interface 1600 relates to an author creating an activity within software system and/or software application such as a Lecture Series, Lesson, Case and Quiz. Once the type of activity has been selected the lower portion 1610 is configured which in this case allows the user to name the quiz, having selected a quiz at the top of user interface 1600, a description of the quiz as well as additional aspects including the time limit for another member to complete the quiz, when the quiz should be available (for example date and time or upon completion of a lecture/lesson) and when the quiz ceases to be available (thereby limiting the window for members to complete the quiz). The user may also determine if the quiz is generally available and visible within an activities list presented to other Communities for example.

Accordingly a user, for example a Fellow, may establish a quiz relating to an item of educational content and define the parameters of the test. Subsequently, they would be able within a second user interface screen to define additional factors relating to the exam (or quiz) such as whether in pre and post-test competency assessments whether to compare multiple groups, control groups at a single time point, or groups over an extended period of time, and also whether the examination duration should be adjusted according to the level of the user based for example upon their pre-test competency assessment or whether they are a year 1, 2, or 3 student for example. The user defining the test may also establish the type of quiz/exam such as True/False, Multiple Choice, and Short Answer. Amongst the test types a user may choose include A/B comparative tests by which a baseline control sample may be compared to a variety of single-variable test samples or two different tests compared or one or more variants of A/B testing such as A/B/N and A/B/A tests with more than two alternative test groups and repeated alternative respectively.

Alternatively one or more other test types may be employed including but not limited to Choice Modelling and Multivariate testing. For example Choice Modelling may be used to determine whether certain specific additional information if available to the users would have adjusted the distribution of their diagnoses to the appropriate one. It would be evident that according to embodiments of the invention such A/B tests, Choice Modelling, and Multivariate testing protocols may be rapidly and automatically generated for one or more subject materials, user groups, communities etc. Such protocols may be applied to not only establish test protocols, but verify cases within a test case bank, test users, and test procedures. Further such testing may be structured or randomized across cases, users, etc as well as subject matter such that randomized A/B testing may be performed with content from multiple communities.

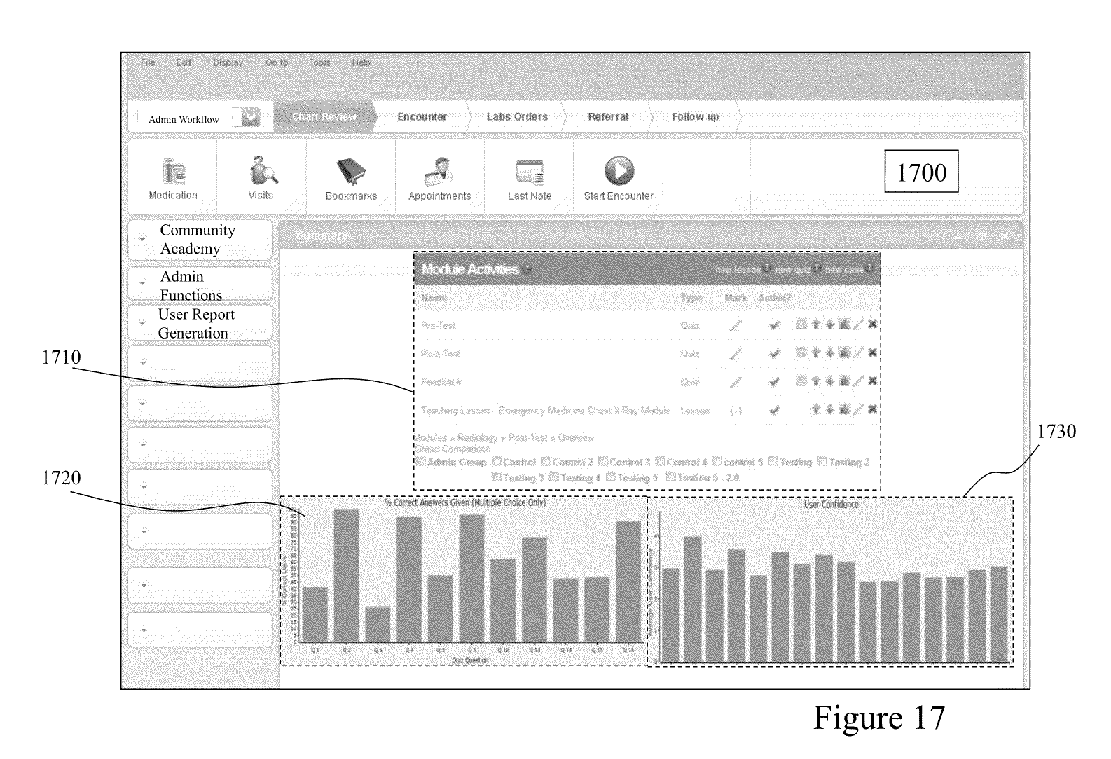

Upon completion of an exam or quiz the software system and/or software application provides analysis and feedback relating to the module undertaken by a group of members. FIG. 17 depicts an examination reporting screenshot image 1700 presented to a member relating to “Emergency Medicine Chest X-ray Module.” Module Activity block 1710 denotes the different activities active, e.g. pre-test, post-test, and feedback together with indications of the options for each. In this instance all are active such that the member reviewing the results can see that feedback will be provided to the members who took the test and that a pre-test competency step was completed and there is a post-test step.

First result summary 1720 depicts the percentage of correct answers by question for those that were multiple choices only in this instance. Second result summary 1730 provides a measure of user confidence based upon factors determined during monitoring of the quiz/exam such as for example the number of times the user changed a selection, the average time to make a selection, and the average time to make a selection weighted by accuracy. It would be evident that automated monitoring of examination/quiz results wherein interpretation of information, such as for example X-ray images, cardiac traces, MRI data etc, may be considered subjective is included that over an extended number of groups statistically significant information may be derived such as a consistent problem with particular subject matter allowing the lessons/lectures to be adjusted or that a particular question is never answered correctly indicating a potential issue with the case study material(s) employed to provide the question to the user. In such instances the software system and/or software application may automatically send a message to the quiz/exam author and/or lesson/lecture author indicating the findings.

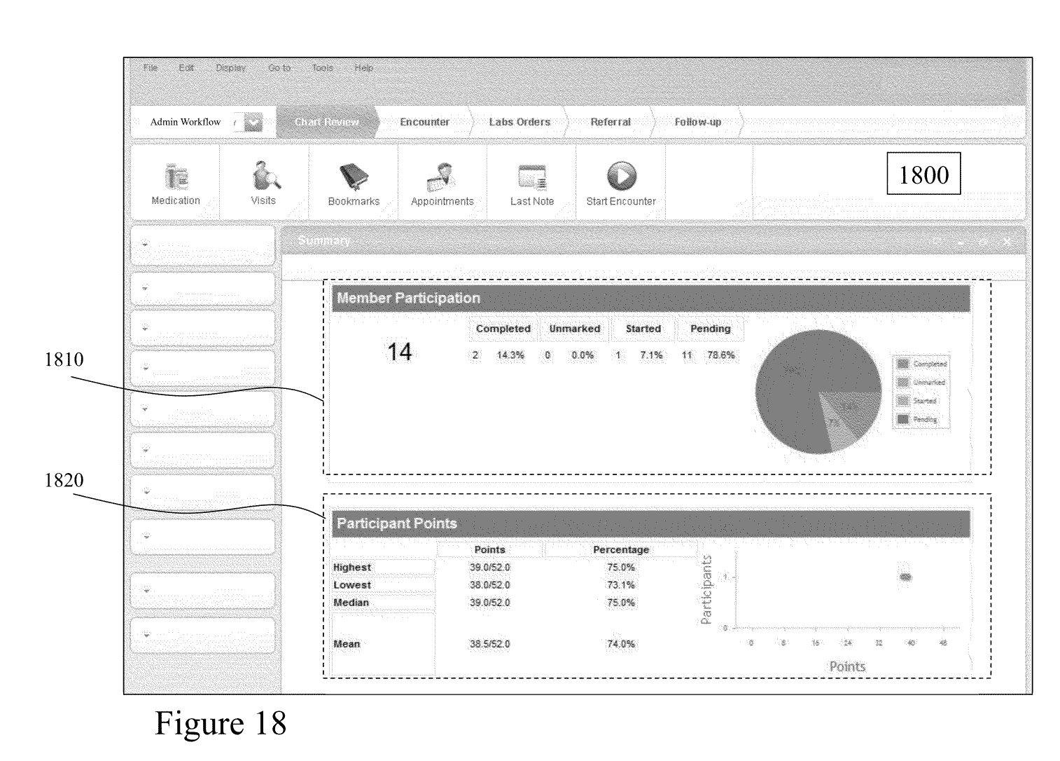

Referring to FIG. 18 there is depicted a reporting screenshot image 1800 presented to a user of a software system and/or software application according to an embodiment of the invention. Upper section 1810 depicts a status of an examination for a group of 14 members indicating the number of completed examinations, the number of completed examinations unmarked, and the number of pending examinations. In the lower section 1820 statistical information relating to the examination is presented. In this instance with only 2 marked examinations the statistics are limited but it would evident to one skilled in the art how this may increase with the completion of the overall group of exams and that additional information may be also displayed including for example high/low/mean/median data over a predetermined number of prior examinations, number of participants, or time period. Within an administrative reporting workflow of which reporting screenshot image 1800 forms part may include creating activities, delegating content development, approve content, basic statistical analysis, and exporting results into statistical analysis software (SAS) and SPSS software (Statistical Package for the Social Sciences).

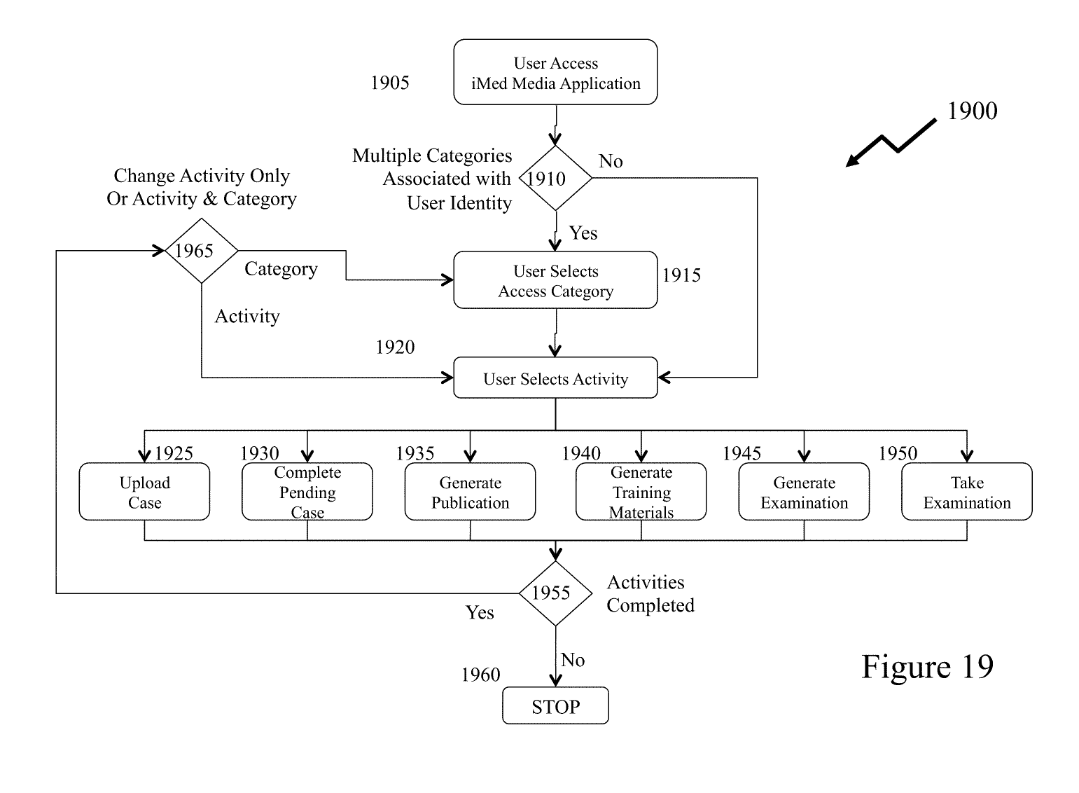

Referring to FIG. 19 there is depicted an exemplary process flow 1900 for a user accessing a software system and/or software application according to an embodiment of the invention. The process begins with a user accessing an software system and/or software application in step 1905 wherein the process proceeds to step 1910 and determines whether the user has access to multiple categories or not. Such categories for example may include administration, student, and creator according to the user's identity and/or position within an institution utilizing software system and/or software application and hosting one or more Communities. If the user does not have multiple categories the process proceeds to step 1920 otherwise it proceeds to step 1915 for the user to select a category prior to proceeding to step 1920 wherein the user selects an activity. According to the user's identity and the category associated with or selected by the user the activities available may include Upload Case 1925, Complete Pending Case 1930, Generate Publication 1935, Generate Training Materials 1940, Generate Examination 1945, and Take Examination 1950.

Upon completion of the activity the user selects in step 1920 and completes in the selected one of Upload Case 1925, Complete Pending Case 1930, Generate Publication 1935, Generate Training Materials 1940, Generate Examination 1945, and Take Examination 1950 the process proceeds to step 1955. In step 1955 the user determines whether they have completed their activities, wherein if yes the process proceeds to step 1960 and stops otherwise it proceeds to step 1965 wherein the user determines whether they need to select just a new activity or change their category as well and accordingly proceeds to step 1920 or step 1915.

Now referring to FIG. 20 there is depicted an exemplary process flow 2000 for a user adding cases to software system and/or software application according to an embodiment of the invention. Accordingly, process flow 2000 begins at step 2005 wherein a Fellow or Resident, having previously accessed the software system and/or software application and selecting to upload a case such as described in respect step 1925 in FIG. 19 above, uploads a case to an interim case bank whereupon the process proceeds to step 2010 and determines whether the uploaded case is complete or not. A positive determination results in the process proceeding to step 2035 wherein the software system and/or software application flags the completed case with a yellow flag otherwise the process proceeds to step 2015. In step 2015 the software system and/or software application assigns an incomplete status to the case and identifies it with a red flag.

Subsequently in step 2020 the software system and/or software application alerts medical students associated with the category/subject or the Fellow/Resident that incomplete cases exist within the case bank. Accordingly, a medical student may through a process flow such as described above in respect of FIG. 19 may elect to complete a case through step 1930 in process flow 1900 wherein completion of that activity corresponds to completion of process step 2025 in process flow 2000. Once completed the process notifies the Fellow/Resident that the completed case exists wherein the Fellow/Resident may approve the case in step 2030. Optionally, the Fellow/Resident may reject the completed case and using a sub-flow not included within process flow 2000 for clarity iterate to completion/approval with the medical student by passing the case back for revision etc.

Upon approval of the case the process flow proceeds again to step 2035 wherein the completed case is flagged with a yellow flag. Next in step 2040 the process proceeds to extract from the patient records the waiver information relating to the patient to whom the case information relates. If a determination in step 2045 is made that the waiver information exists the process proceeds to step 2050 and associates the waiver information, such as for example the waiver categories that are positively waived by the patient as described above in respect of FIG. 5, changes the case flag to green and proceeds to step 2055 wherein the case is released to the case bank with a green flag indicating that waiver information exists allowing the case to be included, if the same categories as employed in FIG. 7 are tracked in one or more of “McGill School Use”, “General Use”, and “Publication.” Determination in step 2045 that no waiver information exists results in the process proceeding to step 2055 wherein software system and/or software application changes the case flag to black and notifies an administration member of the Community that it would be desirable to obtain the patients waiver to allow the case to incorporated within the case bank, and the process proceeds to step 2060 and the case is released with a black flag.

If the administration member subsequently obtains the necessary patient waiver then they may access enter that information within the patients EMR/EHR records. In some embodiments of the invention this may result in an automatic check of all cases within the case bank with black flags to identify whether a case exists and thereby changing its case flag to green or an administrative member of the Community may through an administration function access the case directly and make the necessary adjustments to waiver fields and change the flag to green. An automated system may in many instances be preferable to avoid erroneous adjustment of flag status thereby potentially leaving the medical institution liable upon release of that confidential information. It would be further evident that with the desired transition to state, provincial, national EMR/EHR records that a waiver placed within a patients file may be related only to specific portions of their records and that each subsequent interaction with another medical facility may require additional waivers or the patient may be asked to sign a blanket waiver relating to all their records and their use within software system and/or software application.

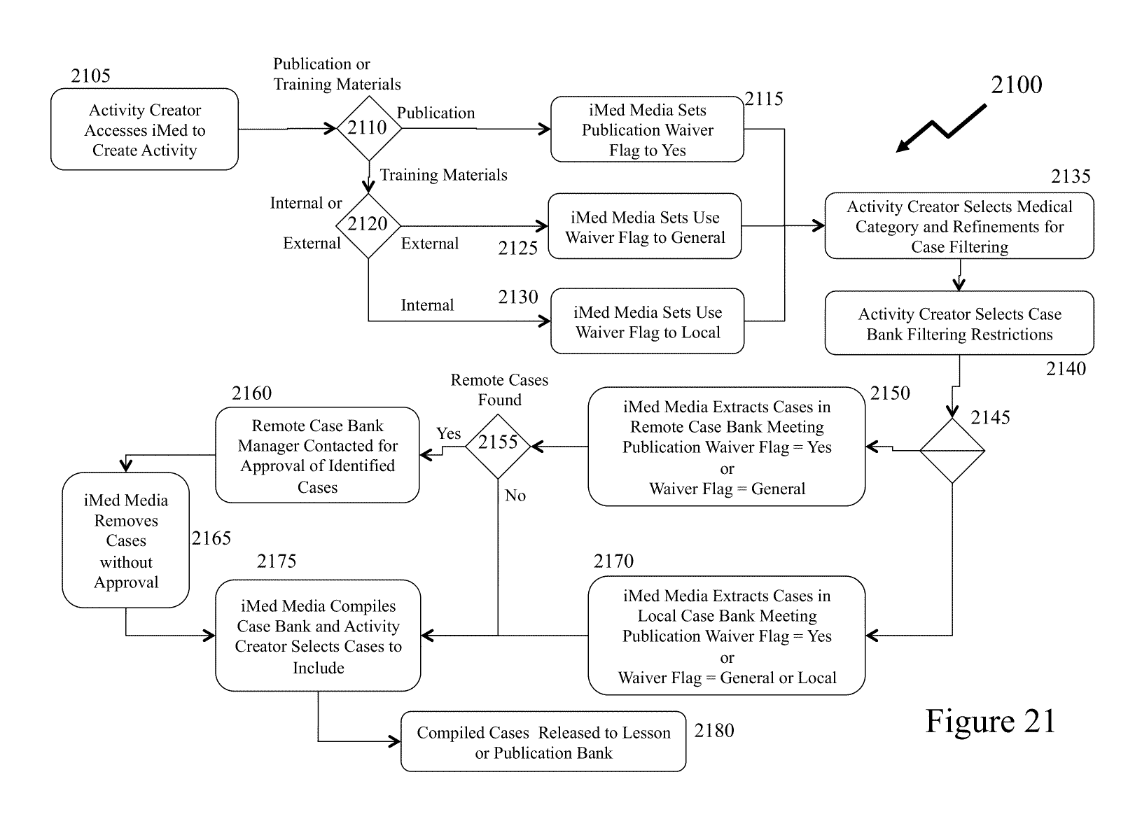

Now referring to FIG. 21 there is depicted an exemplary process flow 2100 for a user compiling an activity using a software system and/or software application according to an embodiment of the invention. As depicted the process flow 2100 begins once a user has logged into the software system and/or software application and selected a Create Activity function in step 2105 including, but not limited to, Generate Publication 1935, Generate Training Materials 1940, and Generate Examination 1945 as depicted supra in respect of FIG. 19. Generate Training Materials 1940 may include for example generating a lesson or a lecture or a lesson for a lecture series. From step 2105 the process proceeds to determine in step 2110 whether the user has selected to generate a publication or training materials wherein the process proceeds to steps 2115 and 2120 respectively. In step 2115 the process sets a publication waiver flag to yes before progressing to step 2235. In step 2120 the process now determines whether the user has selected to generate training materials which will be used internally or will be available externally as well wherein the process proceeds to steps 2130 and 2125 respectively to set a waiver flag to “local” and “general” respectively before proceeding to step 2135.

In step 2135 the creator of the activity selects the category of the activity and adjusts any aspects of the case bank filtering that they wish to amend. For example the creator may select to create a thorasic surgery lecture series but wishes to focus the series towards surgical procedures and X-ray imaging artifacts. Then in step 2140 the process proceeds to allow the activity creator to select restrictions/filters for case bank filtering, such as in this instance the author wishes to restrict cases to post-menopausal women and thereby sets a limit to 50 years in age and female for patient criteria wherein no thorasic issues were found but surgeries were performed due to false imaging of masses within the breasts of the patient. Accordingly in step 2145 the process branches in retrieving cases from the case bank to steps 2150 and 2170 in dependence upon whether the creator has established that the case bank search includes remote case banks associated with other Communities or just the local Community (Communities) associated with the user. If the user seeks to search remote case banks then the remote case banks are searched in step 2150 with the publication waiver flag is set to “Yes” or the waiver flag set to “General” whereas in step 2170 the process searches local case banks where the publication waiver flag is set to “Yes” or the waiver flag set to “General” or “Local.”

Considering the process flow from step 2150 then the process proceeds to step 2155 wherein if no remote cases were found the process flow proceeds to step 2175 as does the process flow from step 2170. If in step 2155 a determination is made that remote cases exist the software system and/or software application contacts the managers of the remote case banks in step 2160 for approval to release the identified case wherein upon receipt of their replies the process removes cases that have not been approved in step 2165 and proceeds to step 2175 wherein these released remote cases are merged with the locally identified cases for review by the activity creator such that they may make selections as to which they will finally include within the activity. At this point the process proceeds to step 2180 wherein the compiled selected cases are released to the lesson or publication bank for subsequent management and handling.

Optionally prior to contacting the manager of a remote case bank the process may provide temporary access to the cases allowing the activity creator to review and determine their suitability and/or filter the cases such that the request for release applies only to those that the activity creator actually intends to use. Alternatively where a remote case bank case approval has been granted the software system and/or software application may automatically rescind the approval if the activity creator does not include the case(s) within the final compiled case list released to the lesson or publication bank.

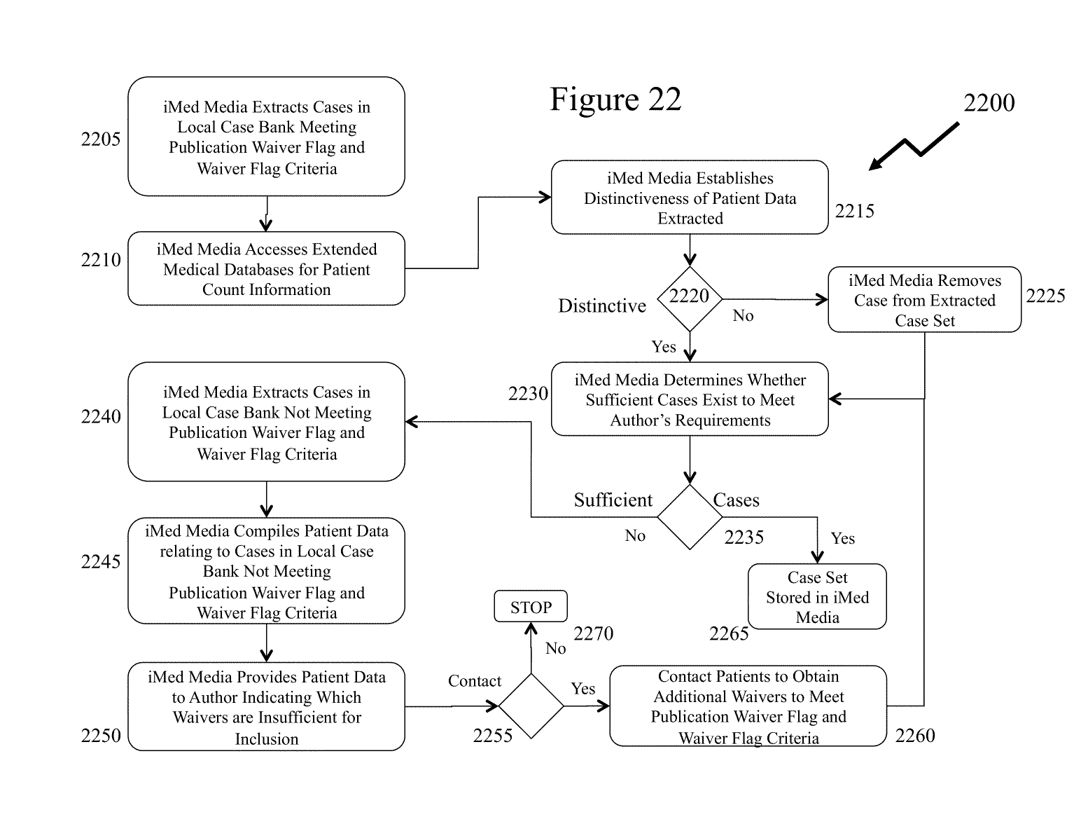

Referring to FIG. 22 there is depicted an exemplary process flow 2200 for a user compiling an activity using a software system and/or software application according to an embodiment of the invention. As shown the process beings in step 2205 wherein the software system and/or software application extracts cases in the local case bank meeting the publication waiver and waiver flag criteria such as discussed above in respect of process flow 2100 and FIG. 21 above. Next in step 2210 the software system and/or software application accesses extended medical databases for Communities associated with the Community within which the user is currently actively creating an activity to extract patient count information. This patient count information relates to the filtering criteria, such that for example, considering the criteria discussed above in respect of FIG. 21 the number of female patients aged 50 who had X-rays, underwent thorasic surgery due to identified issues within the X-rays but upon surgery these issues were found to be non-existent. Next in step 2215 the software system and/or software application establishes a distinctiveness rating for the cases extracted wherein it is determined in step 2220 whether the cases meet a distinctiveness threshold or not. If the cases meet the threshold, i.e. there are sufficient cases overall to make identification of the patient possible from the case data absent their identity being included within the case, then the process proceeds to step 2230 otherwise it proceeds to step 2225 and removes the selected case(s) from the case bank before progressing to step 2230.

Subsequently in step 2230 the process determines whether sufficient cases exist to meet the activity author's requirements. If yes the process proceeds to step 2265 wherein the cases are stored within the software system and/or software application, otherwise the process proceeds to step 2240 wherein the software system and/or software application extracts cases meeting the case requirements of the author but not meeting the waiver requirements required by the author. Next in step 2245 the data relating to these patients is compiled and then provided to the author in step 2250 indicating which waivers are insufficient for the cases to be included wherein they may determine whether to contact one or more of the patients to obtain the necessary missing waiver or waivers. If they decide not to contact the patients the process proceeds to step 2270 and stops directly as insufficient cases exist for the required distinctiveness. If they decide to contact the patients the process proceeds via step 2260 wherein the required waivers may be requested from the patients such that the process loops back to step 2230 and checks whether the additional cases within the case bank are now sufficient for the required distinctiveness threshold to be met.

It would be evident that where cases within the currently selected grouping come from multiple population groupings, e.g. brain tumours affecting 35-44 year olds that statistical distinctiveness may be established separately for men and women for example. Other case groups may have 1, 2, or more groupings requiring distinctiveness analysis. Optionally, rather than removing the cases from the case bank the process may flag these as temporarily removed and notify the activity creator that a specific waiver may be required due to the inability to protect the patient's identity which if acquired allows the case to reinstalled into the case bank. It would therefore be evident that process flow 2200 may iterate with an additional loop should an insufficient number of cases exist after completion of a process sequence wherein the activity creator may adjust the filtering conditions for the cases to try and widen the cases available and adjust the distinctiveness results. It would be evident that in some circumstances such adjustments cannot provide a satisfactory condition such as when for example a condition occurs within the general population at a rate of 1 in 250,000 and the Community/Communities searched only have for example a million patients. In such instances if the patient has signed the “local” waiver then it might be necessary to obtain the “publication” waiver as releasing materials based upon their specific case is essentially releasing the patient's identity due to the rarity of their condition or scarcity of patients actually being treated within a Community of the software system and/or software application.

It would also be evident to one skilled in the art that once a case bank or set of cases has been generated that these may subsequently be automatically updated based upon the case histories within the software system and/or software application allowing the outcomes of decisions made by medical students and/or medical professionals, for example, to be evaluated allowing procedure/diagnosis protocols etc to be adjusted at a discrete medical facility as well as being communicated to other communities etc. For example, chest X-ray's with shadows that were not progressed to further assessment may be analysed for patient outcome to determine whether a change in protocol would have impacted overall patient prognosis/outcome dynamics. It would also be evident that the case bank may be established based upon an outcome and that the patient case status at a particular earlier point in time is retrieved for presentation to medical students and/or medical professionals, for example. For example, all patients at a medical facility having heart bypass operations after suspected heart attacks may be retrieved and medical students presented with their ECG data. Alternatively, such data over a larger number of patients across multiple medical facilities may increase identification of an ECG artifact that has increased correlation to outcome or requirement for intervention.

As discussed above in respect of FIGS. 3 through 22 the software system and/or software application employs cases within case banks to build the different educational, training, examination and qualification activities its supports wherein these cases contain information relating to a variety of aspects of the patient, their diagnosis, treatment, etc but the patient's identity is not included. However, as discussed above in respect of several aspects of the invention traceability back to the original patient and their EMR/EHR records is beneficial to address issues relating to the different educational, training, examination and qualification activities. Accordingly in FIG. 23 there is depicted a schematic 2300 of a patient cross-referencing and identity restriction using a software system and/or software application according to an embodiment of the invention. As depicted a first server 2330 is shown connected to a network 100 and therein to a first medical facility 2310 which operates an EMR/EHR system or similar system which establishes a first database 2335 comprising information relating to patients such as described above in respect of FIGS. 4A and 4B. As shown first database 2335 relates to the University of Ottawa and includes records relating to two locations identified as “Heart” and “Royal” being the University of Ottawa Heart Institute and Royal Ottawa Mental Health Centre respectively.

Also connected to network 100 is a second server 2340 having stored within a second database 2345 as generated and maintained by the software system and/or software application together with a second medical facility 2320. Accordingly, as first and second medical facilities 2310 and 2320 employ the software system and/or software application for different educational, training, examination and qualification activities thereby generating and uploading cases to Communities and case banks wherein each loaded case has cross-reference data stored within the second database including as shown a unique software system and/or software application identifier, the facility loading the case and their internal patient identity information associating the case to the original EMR/EHR records or other system records. Communications to/from the second database 2345 from either of the first and second medical facilities 2310 and 2320 respectively are performed in a secure encrypted manner 2350 using one or more techniques for exchanging confidential information in a secure manner between two computer systems. As evident from second database 2345 with field 2355 a unique identifier relating to a specific patient may be associated with different medical facilities, e.g. first and second medical facilities 2310 and 2320 respectively, as the patient is/has/will receive treatment from both wherein the facility specific identifiers are also stored within the second database 2345 allowing access to first databases 2335 associated with each medical facility. It would also be evident that unique identifiers within the second database 2345 as generated and maintained by the software system and/or software application may include, but not be limited to, patients, clinicians, students, surgeons, nurses, etc allowing such identities to be associated with patient records thereby allowing, for example, a search to be performed relating to patient outcomes from a particular treatment based upon years experience.

Optionally, separate databases may be maintained by the software system and/or software application according to embodiments of the invention to store data relating to the clinicians, students, surgeons, nurses, etc which is cross-referenced to the patient databases(s) such as first and second databases 2135 and 2145 respectively. Alternatively, successful diagnosis rates for a particular medical condition may be accessed, analysed and correlated to establish whether a particular medical training program outperforms the majority allowing best-in-class practices to be subsequently transferred to other organizations. Equally, a medical training facility may be able to follow-up through in respect of its medical students to drive enrollment activities etc. Optionally, a healthcare insurance provider may assess which medical facilities to refer patients to based upon criteria including, but not limited to, current diagnosis, healthcare program, location, facility cost structure, success rate etc. Similarly, financial reporting/financial infrastructure investments etc for national, state, provincial Governments and private organizations etc may be based upon automatically generating statistics, reports, etc from a software system and/or software application according to embodiments of the invention.

Accordingly should the first medical facility 2310 exploit an educational, training, examination or qualification activity generated by the second medical facility 2320, such as presented supra in respect of FIG. 14 with material from McGill University being used by the University of Ottawa, and an issue arises with respect to the activity content traceability of the case or cases at issue is maintained within the software system and/or software application to the original source cases. Optionally, rather than a centralized case database cross-referencing to multiple EMR/EHR systems each Community exploiting the software system and/or software application may establish unique case references locally which are stored with cross-reference to the source case records such that the overall cross-referencing is distributed across each of the medical facilities exploiting software system and/or software application.

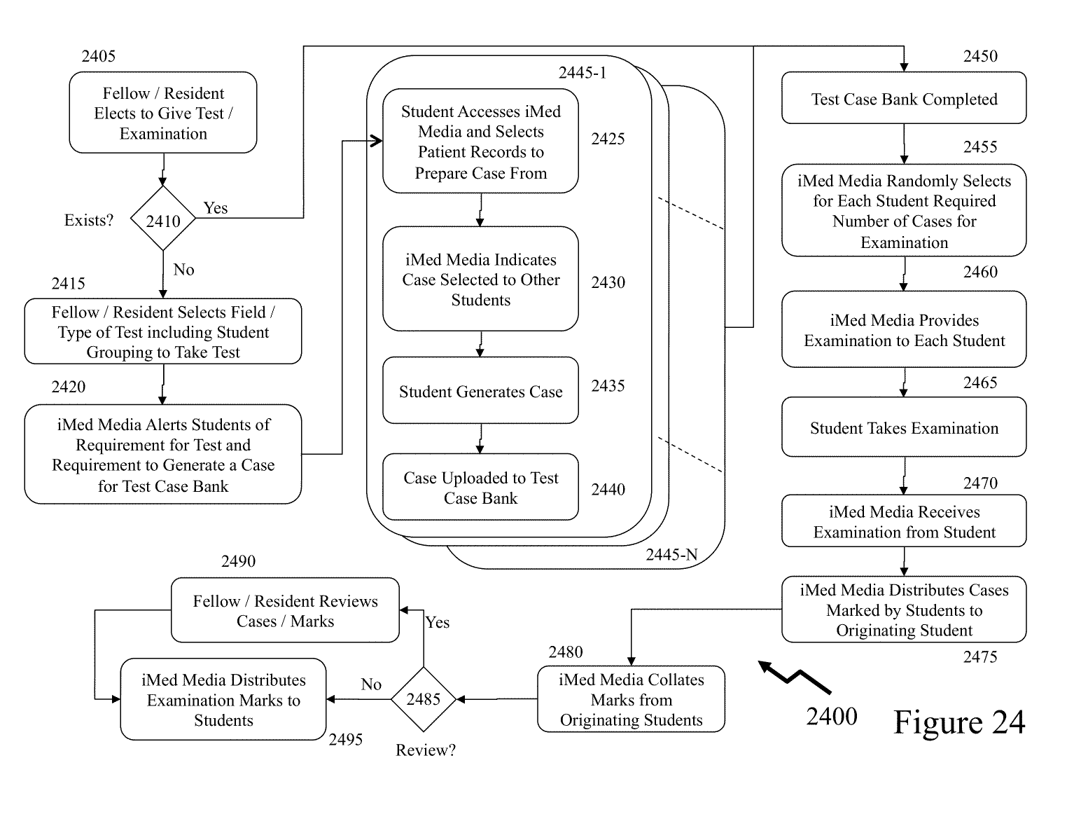

Now referring to FIG. 24 there is presented a process flow 2400 wherein a Fellow/Resident elects to give a test or examination according to an embodiment of the invention. Accordingly in step 2405 the Fellow/Resident elects to give an examination wherein the process determines if the examination exists or not. If it does the examination proceeds to step 2450 otherwise it proceeds to step 2415 wherein the Fellow/Resident selects the field of the examination, type of test, and the student grouping taking the test. Next in step 2420 the software system and/or software application process alerts the students of the requirement to take the test and their requirement to also generate a test for the test case bank.

Accordingly the process proceeds to a plurality of sub-processes 2445-1 through 2445-N wherein each one of the plurality represents a process flow for one student of the grouping selected for the examination. Accordingly in step 2425 the student accesses the software system and/or software application system and selects the patient records to prepare their case from. Next in step 2430 software system and/or software application annotates the case as selected by the student when accessed or displayed as part of a list to other students within the grouping. Accordingly having selected the patient records the student generates the case which is then uploaded to the test case bank in step 2440. Once all test cases are generated by the students the process notes this in step 2450 with completion of the test case bank. Next in step 2455 the software system and/or software application randomly selects for each student the required number of cases for the examination wherein the case that each student generated is removed for them from the case test bank. Accordingly next in step 2460 software system and/or software application provides the examination to each student who then takes the examination in step 2465 such that in step 2470 software system and/or software application receives the completed examination either in a single communication or as the student completes each case.

Next in step 2475 software system and/or software application distributes the completed examinations such that each student receives the answers from other the students that relate to the case they generated. This being performed in a manner that the student only has a reference number for each student so is unaware of the identity of each student. The marking of each student is then collated by the software system and/or software application wherein the Fellow/Resident initiating the test is prompted in step 2485 as to whether they wish to review any aspects of the examination wherein a positive response proceeds to step 2490 where the Fellow/Resident reviews the cases and/or marks and upon completion of this the process proceeds to step 2495. If the determination in step 2485 had been negative the process would have similarly proceeded to step 2495 wherein the marks would have been distributed to the students taking the examination.

It would be evident to one skilled in the art that the process flow 2400 described above in respect of FIG. 24 may alternatively issue the request for cases to other physicians, residents, fellows etc within the same community as the initiator of the examination or other associated communities. Equally each individual contributing may be asked to provide 2 or more cases. It would also be evident that analytic techniques such as those described above in respect of FIGS. 17 and 18 and others may be applied to ensure cases and marks meet the requirements and consistent failed questions are identified. Optionally, the initiating examiner may never see anything except the complete test results. As discussed above the software system and/or software application may establish multiple communities, each community centered upon a generator of a case(s) uploaded to the test case bank wherein the other community members are those students selected to answer that cases(s). Essentially each student therefore receives from the multiple communities multiple exams which combine to provide the overall examination.

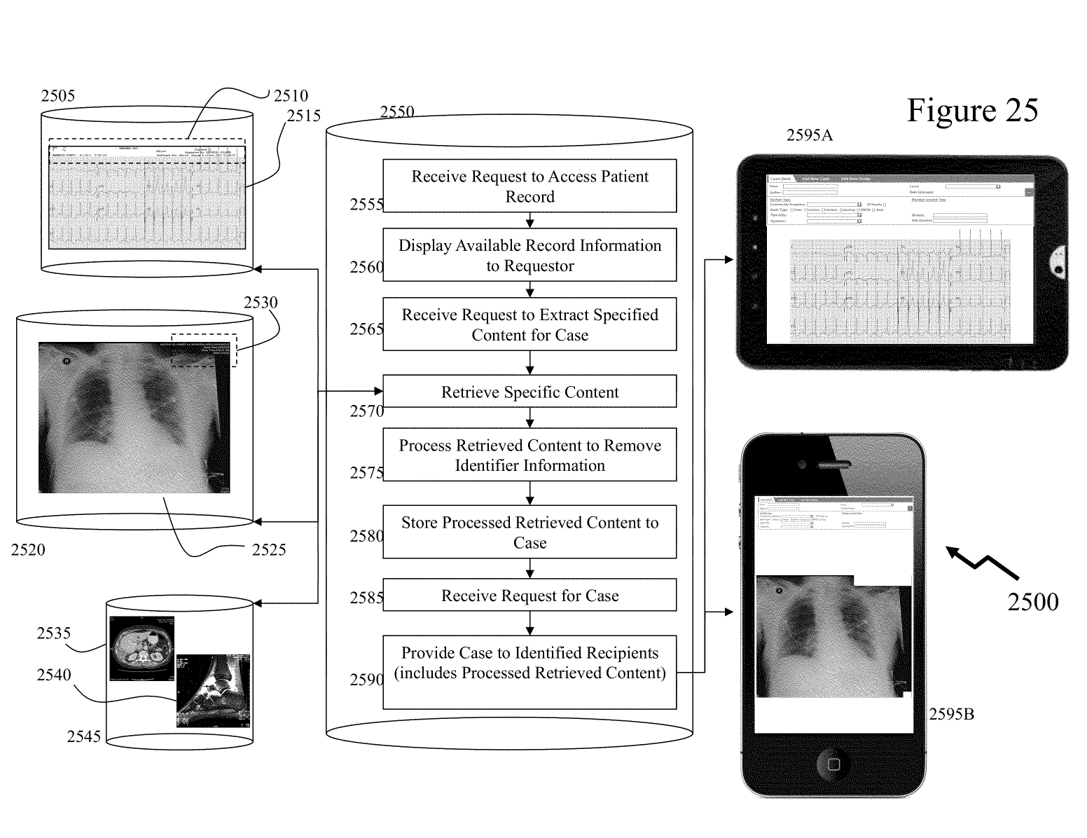

Now referring to FIG. 25 there is depicted an exemplary flow diagram and content sequence relating to the “scrubbing” of case content during the creation of cases. Accordingly there are depicted first to third patent record servers 2505, 2520 and 2545 respectively. Stored within first patient record server 2505 are ECG records 2515 which include first patient identification information 2510, and within second patient record server 2520 are X-ray records 2525 which similarly contain second patient identification information 2530. Third patient record server 2545 contains MRI/CAT scans 2535 and 2545 which likewise contain patient identification information but this has not been highlighted for clarity. Within server 2550 a software system/software application is in execution relating to generation of cases and their management for an educational software system and/or software application as taught above in respect of FIGS. 3 through 26 for example.

Within server 2550 the software system and/or software application executes at least one process of a plurality of process, the process in this instance relating to the generation of cases using patient record content stored within first to third patent record servers 2505, 2520 and 2545 respectively. In process step 2555 the process receives a request to access a patent record which has been selected by a user through one or more menus such as described above in respect of other aspects of the invention that allow a user to search and identify a case meeting criteria they specify. Next in step 2560 the user is presented with available record information which may relate to one or more patient records stored within first to third patent record servers 2505, 2520 and 2545 respectively. Accordingly the user may be presented ECG, X-Ray and MRI/CAT scan content from these databases as relates to the patient. Next in step 2565 the user selects the item or items of patient record information they would like to extract and employ which is provided as a request to the process in execution upon server 2550.

In step 2570 this content is retrieved and then analysed in step 2575 to identify occurrences of patent identification information and remove them. For example, the patient ECG record 2515 may be retrieved together with X-ray 2525. These records may be, for example, converted to one or more standard graphic formats such as JPEG, TIFF, GIF, etc or a vector graphics format wherein an image processing algorithm searches the images for occurrences of textual information. Upon identifying and recognizing an item of text the process determines whether the information relates to information that would provide a recipient of the image the ability to identify the patient from the data within the image. Accordingly the process may remove all text based information by default, remove text based information not associated with predetermined terms as relate to the type of image retrieved, or remove text based upon assumptions of retrieved alphanumeric content purpose. Other approaches may be employed discretely or in combination. Subsequently the scrubbed retrieved content is stored by the process in step 2580 in association with the case identifier.

Subsequently in step 2585 a request for the case is received from a user in step 2585 wherein the case is provided to the intended recipient including the scrubbed content in step 2590. Within FIG. 25 this is indicated by tablet 2595A and smartphone 2595B which display ECG record 2515 and X-ray 2525 respectively without the first and second patient identification information 2510 and 2530 respectively. As discussed supra in respect of FIG. 23 in the event subsequently that it is important to access the patient information due to issues relating to the case for example this may be achieved from an administration/supervisory level through cross-referencing the case and it's allocated identity with the securely stored records within the separate database that correlates software system identifiers with physical patient records.

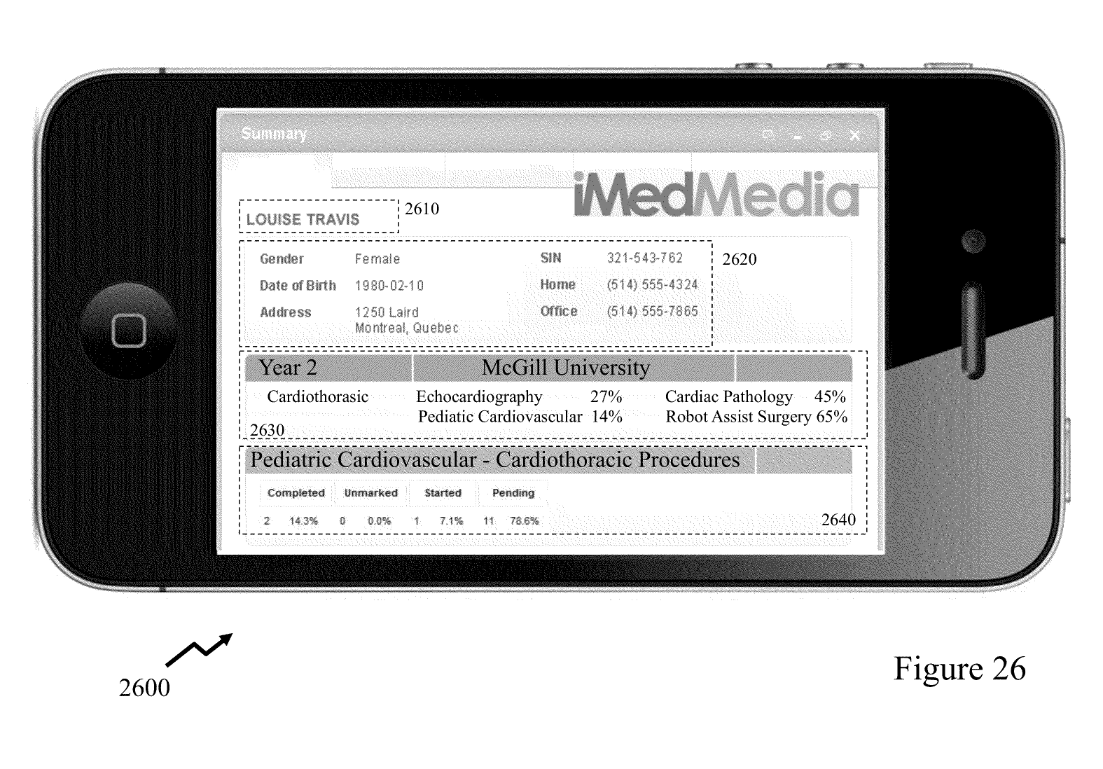

Now referring to FIG. 26 there is depicted a screenshot of an exemplary user interface (UI) 2600 for a PED associated with a user of a software system and/or software application according to embodiments of the invention. As depicted the UI 2600 comprises within this snapshot a summary relating to the user “Louise Travis” identified in header 2610. Below this are User Block 2620, comprising data relating to the user such as address, Social Insurance Number (SIN), and contact details, and Summary Block 2630 relating to the user's activities which are shown in summary form. In this instance, Summary Block 2630 indicates that “Louise” is at McGill University in Year 2 and currently has courses in Echocardiography, Cardiac Pathology, Pediatric Cardiovascular, and Robot Assisted Surgery. Against each is a percentage indicating how far “Louise” has advanced in respect of each. Detail Block 2640 shows that in Pediatric Cardiovascular in respect of Cardiothoratic Procedures they have completed 2, have none pending, 1 started, and 11 pending. Accordingly, the user may track their progress against University requirements as well as those requirements relating to qualification/certification against regulatory, state, and national requirements for example. As such, in order to graduate a student must complete 14 Cardiothoratic Procedures within a Pediatric Cardiovascular rotation.

Tracking such activities within an environment such as a teaching hospital etc can be difficult and accordingly a software system and/or software application such as described according to embodiments of the invention allows for a regulatory body, hospital, student, course supervisor etc to monitor progress. According to an embodiment of the invention the user enters the information themselves, e.g. upon being advised of their scheduling to perform an activity or their completing the activity whilst in another embodiment of the invention the user's data is collated from data entered by third parties such as surgery coordinators, supervisors, etc. or verified by such third parties. In this manner a user and/or their associated trainer/educator/employer may track activities required for certification/qualification/re-qualification etc, as well as employing such data in subsequent predictive and retrospective analytics relating to education etc. For example, a certification requiring a resident perform 50 procedures of type A, 20 procedures of type B, and 35 procedures of type C may be tracked over an extended period of time by the resident and medical facility or a medical training facility may establish that students performing increased procedures against their counterparts may progress to completing residency faster and accordingly adjust their program and marketing to leverage this analysis. Beneficially, such automated analytics may be derived across multiple medical facilities for a single student for example or by a training facility tracking graduates from their program.

It would also be evident to one skilled in the art that the ability to automatically manage activities across multiple facilities would allow for example a doctor with one medical facility to schedule a consultation within another medical facility with automatic communication and billing. Equally, a consultant may provide a consultation on an ad-hoc basis arising from communication from a doctor, for example, may access a software system and/or software application according to an embodiment of the invention to automatically bill the medical facility triggering the ad-hoc consultation as well as entering their consultation results and accessing patient records. Similarly, a software system and/or software application according to an embodiment of the invention may allow the traditional multi-disciplinary “round” to be extended from a single location to multiple medical facility locations.

Such “round” discussions as well as other entries provided in association with a software system and/or software application according to an embodiment of the invention may be captured as audio/audiovisual content in addition to conventional textual/optical character recognition based inputs for example. Such content may be automatically transcribed into text. Optionally, an examination may require an audio element, e.g. giving a patient summary, which may be automatically acquired as part of a test in association with a case or case bank for example, automatically converted to text, and automatically searched for the presence of keywords wherein successful determination of said keywords relates to the mark associated with the test for that student.

According to embodiments of the invention presented and described above in respect of FIGS. 3 through 26 an education or training facility, e.g. teaching hospital, hospital, University, college, business, may rapidly establish tests and/or examinations based upon using for example previously generated examinations within their community, previously generated examinations generated within associated communities, compiled from one or more previously generated examinations, and cases that are stored within case banks associated with their community or associated communities. It would be evident that the actual provisioning of the test and/or examination may be achieved through techniques known to those of skill in the art through dedicated fixed electronic devices such as PCs, kiosks, computer terminals etc and other systems known in the art for audience polling etc. However, according to embodiments of the invention examinations/tests may be held without the requirements for dedicated infra-structure and leverage the near ubiquitous nature of portable electronic devices.

According to a first scenario according to an embodiment of the invention the students have downloaded a software application to their PED wherein upon entering an examination location their PED establishes a connection to a local wireless access point (WAP) wherein at a predetermined point in time the software application downloads or receives the examination which has been pre-populated with the examination content and questions. Accordingly the user interface of the software application would sequentially provide the questions to the user and monitor their responses which would then be communicated from their PED via the local WAP to the software system and/or software application administering the examination for marking, analytics etc. Accordingly the examination may be downloaded for example entirely at the beginning allowing the user to progress at their own pace, question by question so that no user has the full examination at any point in time, or question by question with predetermined time limits that remove the question. It would be evident that the later scenario allows an examination to therefore provide some degree of immediacy and rapid analysis/decision making which may be particularly beneficial where the users are expected in using their expertise to make such decisions, e.g. an Emergency Room physician.

Alternatively the scenario described above may be employed within a teaching/learning environment wherein those students present for a lecture receive the lecture materials over the duration of the lecture thereby encouraging their presence as the materials would otherwise not be available. Alternatively, the materials may be populated during the lecture and retained by the user after the lecture but may have a time limit applied to them such that they are removed from the user's PED at a predetermined point in time such as for example after a deadline for completion of a test relating to the materials or end of semester. It would be evident that the system thereby taught according to the embodiment of the invention allows for a lecturer to pose questions during a lecture and receive responses in real time thereby gauging audience retention of the materials, understanding, etc. Additionally the students may be provided options to give feedback on the quality of the materials and lecturer so that these may be employed in a process of continuous improvement within the educational facility.

It would also be evident that the above embodiment of the invention may be applied to simultaneously providing an examination to a group of students across a larger geographic area than a single examination location. Based upon discrete provisioning of the examination on a question by question basis all students may be provided each question discretely and approximately simultaneously via today's wireless networks without consideration of their geographic location. Accordingly for example a medical examination may be given to all students undertaking a distance learning course within Europe at the same time with timed questions. Further, as an examination may be essentially created from one or more case banks in real time the examination may not have been prepared in advance but is similarly generated in essentially real-time thereby removing potential issues over leaking of examinations etc.

Whilst embodiments of the invention have been described with respect to medical based educational, training, examination and qualification activities it would be evident to one skilled in the art that the methods, techniques, and systems may be applied to the generation of educational, training, examination and qualification content in other applications wherein the content is derived from information that contains confidential information. With reference to medical activities embodiments of the invention allow educational institutions and medical institutions to ensure that they are compliant to regulatory requirements such as the Health Information Protection and Accountability Act (HIPAA) in the United States and the Health Information Protection Act (HIPA) in Canada.

It would also be evident that a medical facility may be a member of a Community or host a Community without being an educational provider. In such instances the medical facility may leverage their position for example to provide tests and/or examinations based upon their reputation for such materials or be a regulator/oversight authority for a particular group of people, for example the Royal College of Physicians and Surgeons in Canada and the Federation of State Medical Boards, the later regulating and managing the United States Medical Licensing Examination.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a process flow may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing a database comprising at least one patient record of a plurality of patient records, each patient record relating to an individual and a medical activity associated with the patient and containing confidential information relating to the patient;
associating with each patient record of the plurality of patient records waiver information relating to a granted waiver;
establishing a profile relating to an educational activity, the profile comprising attributes relating to a medical topic; and
extracting a predetermined portion of the at least one patient record in dependence upon at least the patient records, the profile, and the waiver information wherein the predetermined portion is absent information identifying the patient.

2. The method according to claim 1 further comprising:
determining a statistical significance of the at least one patient record in dependence upon at least the number of instances of patient records occurring that fulfill the attributes of the profile; and
allowing use of the predetermined portion of the at least one patient record when the statistical significance fulfills a predetermined condition.

3. A method comprising:
providing a database comprising at least one patient record of a plurality of patient records, each patient record relating to an individual and a medical activity associated with the patient and containing confidential information relating to the patient;
associating with each patient record of the plurality of patient records waiver information relating to a granted waiver;
establishing a profile relating to an educational activity from a requestor other than a provider relating to the medical activity, the profile comprising attributes relating to a medical topic;
extracting a predetermined portion of the at least one patient record in dependence upon at least the patient records and the profile wherein the predetermined portion is absent information identifying the patient; and
providing the predetermined portion of the at least one patient record to the requestor when the waiver information meets a predetermined condition.

4. The method according to claim 3 further comprising:
determining a statistical significance of the at least one patient record in dependence upon at least the number of instances of patient records occurring that fulfill the attributes of the profile; and
allowing use of the predetermined portion of the at least one patient record when the statistical significance fulfills a predetermined condition.

5. A method comprising:
providing an educational activity to a plurality of users, the educational activity comprising at least one case of a plurality of cases;
monitoring the educational activity to determine at least one characteristic of a plurality of characteristics of the educational activity;
contacting the author of the educational activity when the at least one characteristic meets a predetermined condition.

6. The method according to claim 5 wherein,
generating the case comprises:
providing a database comprising at least one patient record of a plurality of patient records, each patient record relating to an individual and a medical activity associated with the patient and containing confidential information relating to the patient;
associating with each patient record of the plurality of patient records waiver information relating to a granted waiver;
establishing a profile relating to an educational activity, the profile comprising attributes relating to a medical topic; and
extracting a predetermined portion of the at least one patient record in dependence upon at least the patient records, the profile, and the waiver information wherein the predetermined portion is absent information identifying the patient.

7. The method according to claim 5 wherein,
the at least one characteristic relates to that percentage of the users correctly answering a question within the educational activity relating to the at least one case.
